(19) United States
(12) Patent Application Publication
(10) Pub. No.: US 2012/0284276 A1
(43) Pub. Date: Nov. 8, 2012

(54) Access to Annotated Digital File Via a Network

(76) Inventors: Barry Fernando, Phoenix, AZ (US); Mark C. Phelps, Tucson, AZ (US); David Hirschfeld, Scottsdale, AZ (US)

(21) Appl. No.: 13/461,730

(22) Filed: May 1, 2012

Related U.S. Application Data
(60) Provisional application No. 61/481,650, filed on May 2, 2011.
(60) Provisional application No. 61/507,546, filed on Jul. 13, 2011.

(51) Int. Cl. G06F 17/30

(52) U.S. Cl. 707/741; 707/E17.002

(57) ABSTRACT

Apparatuses, systems, and processes provide remote access to virtual objects abstracted from an electronic document. A publisher's electronic document is abstracted into its component virtual objects that are each, in turn, identified. Corresponding computer readable files are formed for respective virtual objects and the computer readable files are indexed. The index is encoded in a non-transitory computer readable medium. Users annotate the virtual objects and the annotations and corresponding annotation metadata are indexed and encoded in the non-transitory computer readable medium. The user annotations are shared amount a plurality of users.

### CROSS-REFERENCES TO RELATED APPLICATIONS

This application claims priority to, and the benefit of, U.S. Patent Application Ser. No. 61/481,650, entitled “Electronic Media Rendition,” filed May 2, 2011, the entire contents of which are incorporated herein by reference; and this application also claims priority to and the benefit of U.S. Patent Application Ser. No. 61/507,546, entitled “Access To Annotated Digital File Via A Network,” filed Jul. 13, 2011, the entire contents of which are incorporated herein by reference.

### FIELD

Embodiments generally relate to apparatuses, methods, devices, and systems for electronic media processing, and more particularly, to providing remote access to virtual objects abstracted from an electronic document.

### COPYRIGHT

Contained herein are materials subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

The digital age has brought with it an expanding amount of electronic content in a plurality of media forms. Content providers and content receivers are challenged with organizing the content for convenient access.

Accordingly, it would be an advance in the art of electronic media processing to provide solutions that can help facilitate organization and access to electronic content.

### SUMMARY

In certain embodiments, an article of manufacture includes a program code to provide remote access to virtual objects abstracted from an electronic document. The programmable code includes steps to effect receiving an electronic document having one or more virtual objects such as a text object, an image object, a sound object, a video object, an interactable graphic object, and a null object. The programmable code includes steps to effect identifying one or more virtual objects comprising the electronic document. The programmable code includes steps to effect forming a corresponding computer readable file encoding a respective virtual object. The programmable code includes steps to effect encoding the corresponding computer readable file in a non-transitory computer readable medium. The programmable code includes steps to effect creating an index referencing the corresponding computer readable file and encoding the index in the non-transitory computer readable medium.

In certain embodiments, a method for annotating a virtual object includes receiving an electronic document having one or more virtual objects, such as: a text object, an image object, a sound object, a video object, an interactable graphic object, and a null object. One or more of the virtual objects that comprise the electronic document are identified. Respective computer readable files are encoded in a non-transitory computer readable medium for corresponding virtual objects. Annotations to one or more virtual objects are received, along with their respective annotation metadata, that are each encoded in the non-transitory computer readable medium in association with the respective computer readable file.

In certain embodiments, a computer program product includes computer readable program code which causes a programmable processor to receive an electronic document having one or more virtual objects, such as a text object, an image object, a sound object, a video object, an interactable graphic object, and a null object. The corresponding metadata associated with the respective virtual objects are also received. The computer readable program code causes the programmable processor to identify one or more of the virtual objects that comprise the electronic document, wherein the identifying further comprises identifying the corresponding virtual object using the respective metadata. The computer readable program code causes the programmable processor to form a corresponding computer readable file encoding the respective virtual object and encoding the corresponding computer readable file in a non-transitory computer readable medium. The computer readable program code causes the programmable processor to create an index referencing the corresponding computer readable files and encoding same in the non-transitory computer readable medium.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates Applicants' system for providing remote access to virtual objects abstracted from an electronic document;

FIG. 2 is a schematic illustrating an electronic document with virtual objects;

FIG. 3 is a schematic illustrating computer readable files encoded in a non-transitory computer medium;

FIG. 4 is a schematic illustrating shared annotations to virtual object computer readable files;

FIG. 5 is a schematic illustrating a sound annotation to a video object;

FIG. 6 is a flow chart illustrating a method for providing remote access to virtual objects abstracted from an electronic document; and

FIGS. 7-31 include screen shots of exemplary user interfaces rendered on a computing device electronic reader.

### DETAILED DESCRIPTION

The invention is described in preferred embodiments in the following description with reference to the FIGS., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

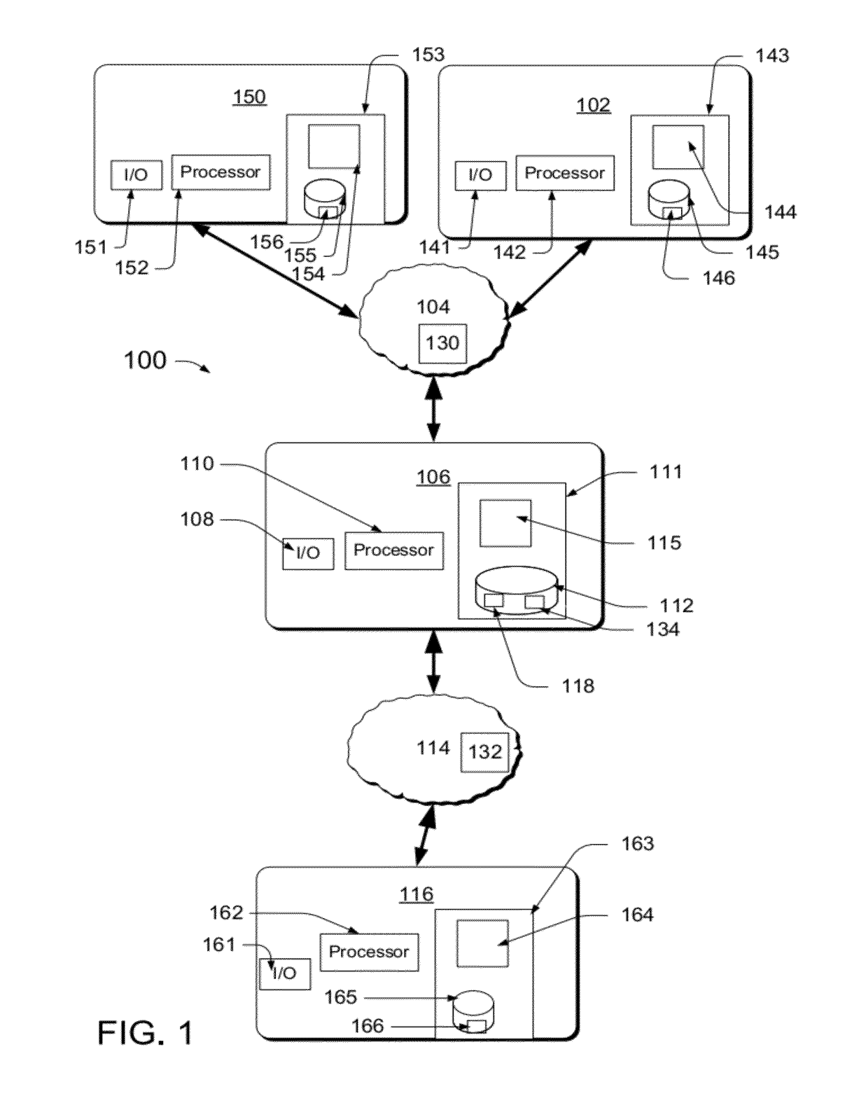

FIG. 1 illustrates a system 100 for creating, organizing, approving, indexing, annotating and/or providing access to electronic content, such as providing remote access to virtual objects abstracted from an electronic document. In the illustrated embodiment of FIG. 1, system 100 comprises a computing device 106 that is communicatively connected to a computing device 116 through a first communication fabric 114; and to a computing device 102 and a computing device 150 through a second communication fabric 104.

In certain embodiments, the computing device 102 is a computing device that is owned and/or operated by a client (“client computing device 102”). Clients are content provides that manage a virtual library such the following entities: a professional organization, a publisher, a university, a professor, a school district, a teacher, a governmental entity, an employer, and the like. In certain embodiments, the computing device 150 is a computing device that is owned and/or operated by a publisher (“publisher computing device 150”). Examples of publishers are content providers, such as a publishing company or author. In certain embodiments, the computing device 106 is a computing device that is owned and/or operated by a host (also “host computing device 106”); and the computing device 116 is a computing device that is owned and/or operated by a user (“user computing device 116”) of the system 100. Examples of users include consumers (e.g., book purchasers), individuals, corporations, magazine subscribers, students, employees, content receivers, and the like.

For the sake of clarity, FIG. 1 shows a single computing device 102, computing device 150, computing device 106, and computing device 116. Moreover, although FIG. 1 shows two communication fabrics 104 and 114, FIG. 1 should not be taken as limiting. Rather, in other embodiments any number of entities and corresponding devices can be part of the system 100, and further, fewer or more entities and corresponding computing devices are also contemplated. Further, in other embodiments more or less than two communication fabrics could be provided in the system 100. For example, in certain embodiments, the publisher is the client and/or the user or the client is the user and their corresponding computing devices are the same computing device. To illustrate, the publisher is also the client that manages a client library; here the publisher computing device 150 is also the client computing device 102. In another example, the publisher is the user that both uploads the original electronic content and annotates the original electronic content using the publisher computing device 150 that is also the user computing device 116.

In certain embodiments, the computing device 102, computing device 150, the computing device 106, and the computing device 116 are each an article of manufacture. Examples of the article of manufacture include: a server, a mainframe computer, a mobile telephone, a multimedia-enabled smartphone, a tablet computer, a personal digital assistant, a personal computer, a laptop, a set-top box, an MP3 player, an email enabled device, a web enabled device, or other special purpose computer each having one or more processors (e.g., a Central Processing Unit, a Graphical Processing Unit, or a microprocessor) that is configured to execute an algorithm (e.g., a computer readable program or software) to receive data, transmit data, store data, or performing methods. Each computing device 102, 106, 116, and 150 includes a non-transitory computer readable medium having a series of instructions, such as computer readable program steps encoded therein. In certain embodiments, the non-transitory computer readable medium includes one or more data repositories.

By way of illustration and not limitation, FIG. 1 illustrates the computing device 102, the computing device 106, the computing device 116, and the computing device 150 as each including: a processor (142, 110, 162, and 152, respectively) a non-transitory computer readable medium (143, 111, 163, and 153, respectively) having a series of instructions, such as computer readable program steps encoded therein; an input/output means (141, 108, 161, and 151, respectively) such as a keyboard, a mouse, a stylus, touch screen, a camera, a scanner, or a printer. The non-transitory computer readable mediums 143, 111, 163, and 153 each include corresponding computer readable program code (144, 115, 164, and 154, respectively) and data repository (145, 112, 165, and 155, respectively). The processors 142, 110, 162, and 152 access the computer readable program codes (e.g., 144, 115, 164, and 154,), encoded on the corresponding non-transitory computer readable mediums (143, 111, 163, and 153, respectively), and executes one or more corresponding instructions (146, 118, 166, and 156, respectively). In certain embodiments, computing devices 102, 106, 116, and 150 employ hardware and/or software that support accelerometers, gyroscopes, magnetometers (e.g., solid state compasses) and the like.

In certain embodiments, the processors 142, 162, and 152 access corresponding Application Program Interfaces (APIs) encoded on the corresponding non-transitory computer readable mediums (143, 163, and 153, respectively), and execute instructions (e.g., 146, 166, and 156, respectively) to electronically communicate with computing device 106, for example. Similarly, the processor 110 accesses the computer readable program code 115, encoded on the non-transitory computer readable medium 111, and executes an instruction 118 to electronically communicate with the computing device 102, 116, and/or 150 via the respective communication fabric. A log 134 is maintained of the data communicated or information about the data communicated (e.g., date and time of transmission, frequency of transmission . . . etc.) with any or all of the computing devices 102, 116, and 150. In certain embodiments, the log is analyzed and/or mined

In certain embodiments, the data repositories 145, 112, 165, and 155 each comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, one or more of the data repositories 145, 112, 165, and 155 is structured by a database model, such as a relational model, a hierarchical model, a network model, an entity-relationship model, an object-oriented model, or a combination thereof For example, in certain embodiments, the data repository 112 is structured in a relational model that stores a one or more virtual objects comprising an electronic document.

In certain embodiments, the computing devices 102, 106, 116, and 150 include wired and/or wireless communication devices which can employ various communication protocols including near field (e.g., “Blue Tooth”) and/or far field communication capabilities (e.g., satellite communication or communication to cell sites of a cellular network) that support any number of services such as: telephony, Short Message Service (SIMS) for text messaging, Multimedia Messaging Service (MMS) for transfer of photographs and videos, electronic mail (email) access, or Global Positioning System (GPS) service, for example. In certain embodiments, the computing devices employs hardware and/or software that supports accelerometers, gyroscopes, solid state compasses and the like.

The communication fabrics 104 and 114 comprise one or more switches 130 and 132, respectively. In certain embodiments, the communication fabrics 104 and 114 comprise the Internet, an intranet, an extranet, a storage area network (SAN), a wide area network (WAN), a local area network (LAN), a virtual private network, a satellite communications network an interactive television network, or any combination of the foregoing. The communication fabrics 104 and 114 contain either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 104 and 114 utilize any of a variety of communication protocols, such as Transmission Control Protocol/Internet Protocol (TCP/IP), for example.

In certain embodiments data is received from one or more computing devices 102, 106, 116, and 150 and stored on the “Cloud” such as a data storage library. Each of the data repositories 145, 112, 165, and 155 has corresponding physical storage devices. In certain embodiments, data storage libraries are configured in a Peer To Peer Remote Copy (“PPRC”) storage system, wherein the data in a first data storage library (e.g., a storage library at data repository 112) is automatically backed up in a second data storage library (e.g., a storage library at data repository 165). In certain embodiments, Applicants' PPRC storage system utilizes synchronous copying. In certain embodiments, Applicants' PPRC storage system utilizes asynchronous copying.

By way of example, in certain embodiments, computing devices 102, 106, 116, and 150 are each communicatively connected to their respective communication fabrics 104, such as a WAN or Internet. In certain embodiments, the computing device 106 provides access to the computing devices 102, 116, and 150 to execute the computer readable program code 115 via a Software as a Service (SaaS) means.

One or more portions of the system 100 can be implemented as a web-based software application. Although not shown, in some embodiments, at least one or more portions of the system 100 can be implemented as a software and/or hardware module that can be locally executed on one or more of the computing devices. In such instances, other functionalities of the system 100 can be accessed via the communication fabrics 104 and 114. For example, a software application locally installed at the user computing device 116 can be used to access at least a portion of the system 100.

In certain embodiments, the system 100 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with, for example, the system 100 can be performed by different modules and/or combined into one or more modules are locally executable on one or more computing devices 102, 106, 116, and/or 150.

Applicants' computer readable program code 115 is encoded in a non-transitory computer readable medium 111 of a host computing device 106. In certain embodiments, processor 110 executes Applicants' computer readable program code 115 to allow a client and/or a publisher to upload an electronic document including virtual objects, such as uploading the electronic document onto a cloud. The host computing device 106 abstracts the virtual objects from the electronic documents and indexes them such that they are searchable without having to search the entirety of the electronic document. Users, in turn, implement Applicant's computer readable program code 164 on a corresponding user computing device 116 to publically and/or through an exclusive membership, access the client library. The user, in turn, accesses the electronic content in the client library and annotates one or more virtual objects. In certain embodiments, the user, shares the electronic document, the virtual object, and/or the annotations with other users in the system 100.

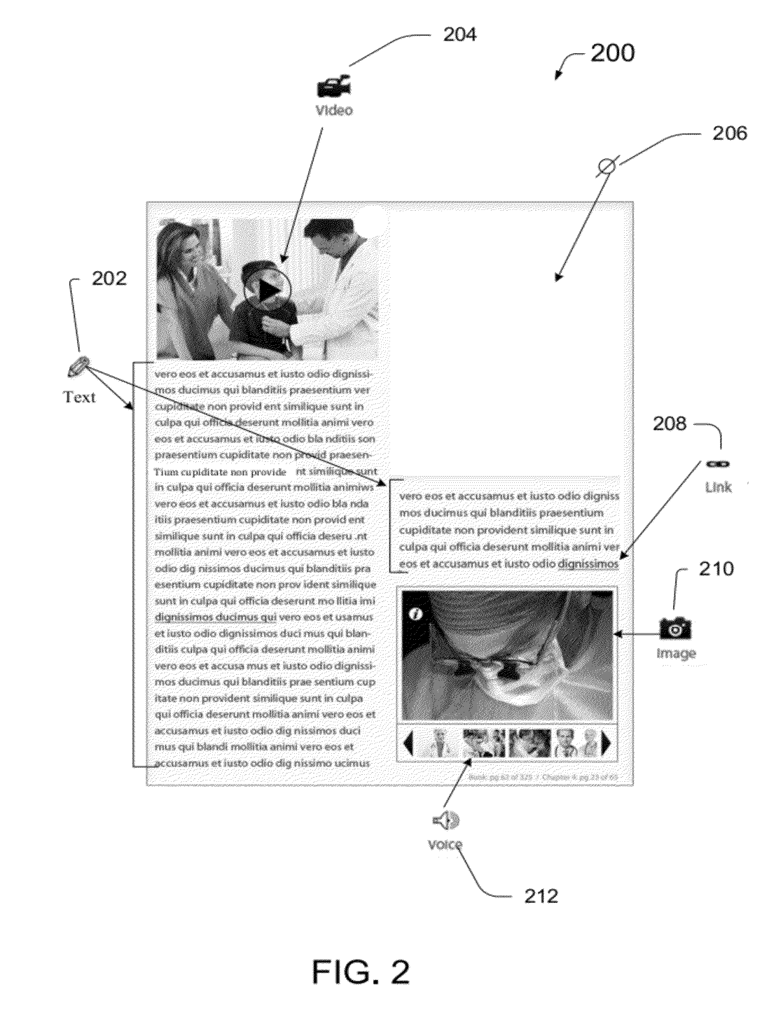

Referring to FIG. 2, a schematic illustrates an electronic document 200. Examples of an electronic document include a digitized: image of a hard copy printed page, lithograph, book, trade journal, brochure, and the like. In FIG. 2, the electronic document 200 is a page from an electronic book that includes virtual objects that make up the page 200. Here, the virtual objects are shown as a text object 202, a video object 204, a null object 206, an interactable graphic object 208 (e.g., hyperlink to inside the electronic document or to a website), an image object 210, a sound object 212. Further examples of virtual objects include: logical objects, numbers, characters, strings (sequence of characters), photographs, scanned paintings, data tables, arrays, graphs, program files, and the like.

In certain embodiments, the electronic document and the virtual objects in the electronic document are each associated with a respective metadata, which provide information about the corresponding virtual object. Metadata provides descriptive, structural, or administrative information about the respective virtual object. Descriptive metadata is the information used to search and locate the respective virtual object such as title, author, subjects, keywords, publisher; structural metadata gives a description of how the components of the virtual object are organized; and administrative metadata includes technical information such as file type.

Examples of metadata includes data about: means of creation of the electronic document, time of creation of the electronic document, location of a computer network where the electronic document was created, a layout of the electronic document, a name of an author of a virtual object, a length of a text object, a font or language of a text object, a short summary of the text object, a time and date when the text object was last updated, an image caption of an image object, size and resolution of an image object, color depth of an image object, time and date when a sound object was created, a topic of a sound object, a transcript of conversations in a video object, a textual description of scenes in frames of a video object, a location of a null object in a page, and the like.

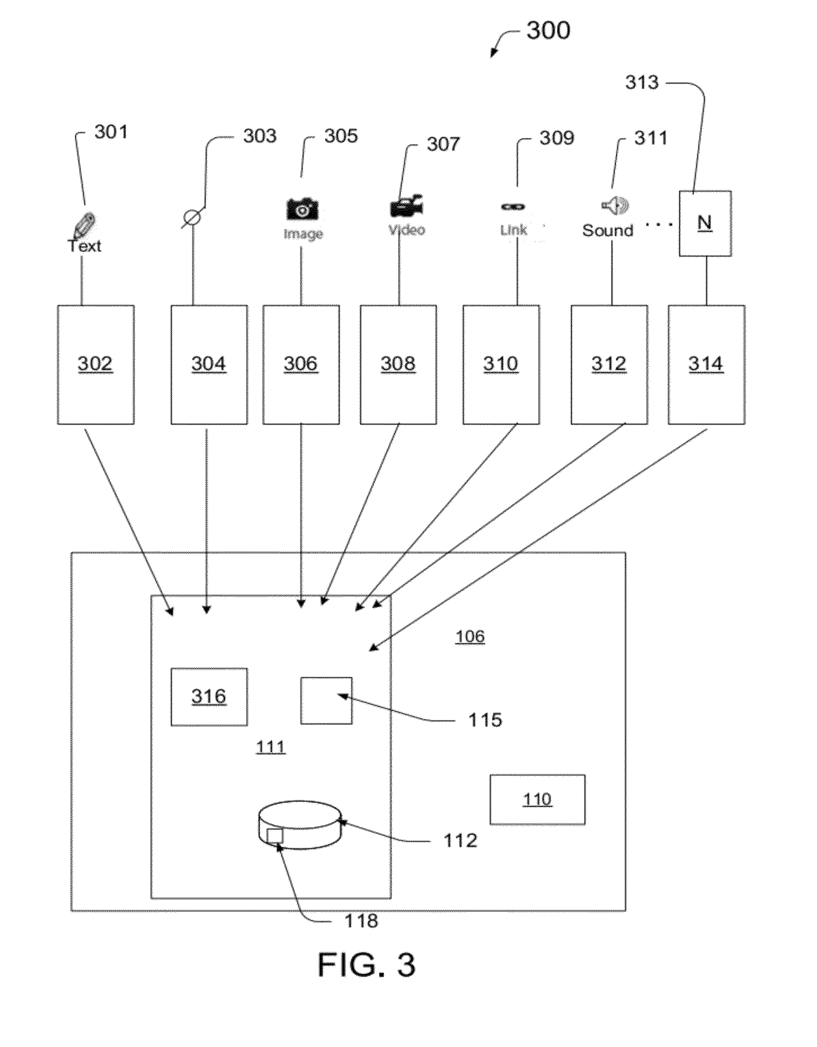

Referring to FIG. 3, the host computing device 106 receives an electronic document (e.g., electronic document 200 of FIG. 2), and abstract the virtual objects included in the electronic document. Here, the processor 110 executes Applicants' computer readable program code 115 to identify (N) virtual objects within the electronic document, where N is equal to or greater than one. In FIG. 3, N=7, where the virtual objects are: a text object 301, a null object 303, an image object 305, a video object 307, an interactable graphic object 309, a sound object 311, and an Nth virtual object 313. Here, the host computing device 106 identifies each virtual object, such as identifying the image object 305 as an image of an operating room, and so on. For example, the host computing device 106 analyzes the corresponding metadata associated with the image object 305 in the electronic document and based on the data in the metadata, identify virtual object as image object 305.

Another means for identifying a virtual object include using a context in the proximity of the virtual object to identify the virtual object. To illustrate, if a text object proximate to an image object is about orthopedic surgery, then the image object is identified as being about orthopedic surgery. Similarly, if a text object has a high frequency of occurrence for a particular word or phrase, the text object is identified based on the highly frequent word or phrase (e.g., if a 500 word text object has the word “surgery” 25 times, then the text object is identified as being about “surgery”). Yet another means for identifying the virtual object is by scanning the virtual object. For example, color scale, shapes, lines, and layout of an image object is detected and the topic of the image object is probabilistically determined to identify the image object. Alternatively, or in combination, at least a portion of the image object is converted to text, such as via Optical character recognition, and the corresponding text is used to identify the image object. Yet another means for identifying virtual object, such as a first virtual object, is by analyzing a second virtual objects or metadata of the second virtual objects that are associated with the first virtual object. For example, if a first virtual object that is an image is associated with a second virtual object that is a video of orthopedic surgery, then the first virtual object that is an image is identified as being about orthopedic surgery. Yet another means for identifying the virtual object is by having editors analyze the electronic document and/or corresponding virtual objects and manually input corresponding data about the same. In yet a further means for identifying the virtual object is by analyzing user comments that are manually entered in association with the electronic document and/or corresponding virtual objects.

In certain embodiments, the host computing device 106 forms corresponding computer readable files encoding each respective virtual object. Here, an (i)th computer readable file encoding an (i)th virtual object is formed. To illustrate, in FIG. 3, computer readable files 302, 304, 306, 308, 310, 312, and 314 are formed encoding the virtual objects: text object 301, null object 303, image object 305, video object 307, interactable graphic object 309, voice object 311, and Nth virtual object 313, respectively. The corresponding computer readable files are encoded in the non-transitory computer readable medium 111.

Further, in certain embodiments, the corresponding metadata is cataloged in the non-transitory computer readable medium 111. The metadata, as data, is storable and/or manageable. For example, a metadata associated with the video object 307 is stored in the data repository 112, such as a metadata registry, in association with the video object 307. In certain embodiments, the metadata is stored internally, in the same file as the corresponding virtual object or electronic document. Alternatively, or in combination, the metadata is stored externally, in a separate file as the corresponding virtual object or electronic document.

In certain embodiments, the host computing device 106 forms a corresponding identifier for each respective computer readable file. For example, the host computing device 106 forms an (i)th identifier associated with the (i)th computer readable file, which (i)th identifier is then encoded in the non-transitory computer readable medium 111. In certain embodiments, the (i)th identifier is also associated with the corresponding (i)th metadata of the (i)th virtual object.

The host computing device 106 indexes each computer readable file. For example, the host computing device 106 creates an index 316 referencing the (i)th computer readable file, such as the computer readable file 306 of the video object 307. To illustrate, the index 316 includes: keywords that describe the video object 307, the name of the videographer that created the video object 307, a date of creation of the video object 307, the electronic document that the video object 307 originated from a category of the video object 307 (e.g., “orthopedic”), and the like. In certain embodiments, the index 316 is based on data in the corresponding metadata associated with the virtual object. The index 316 is, in turn, encoded in the non-transitory computer readable medium 111.

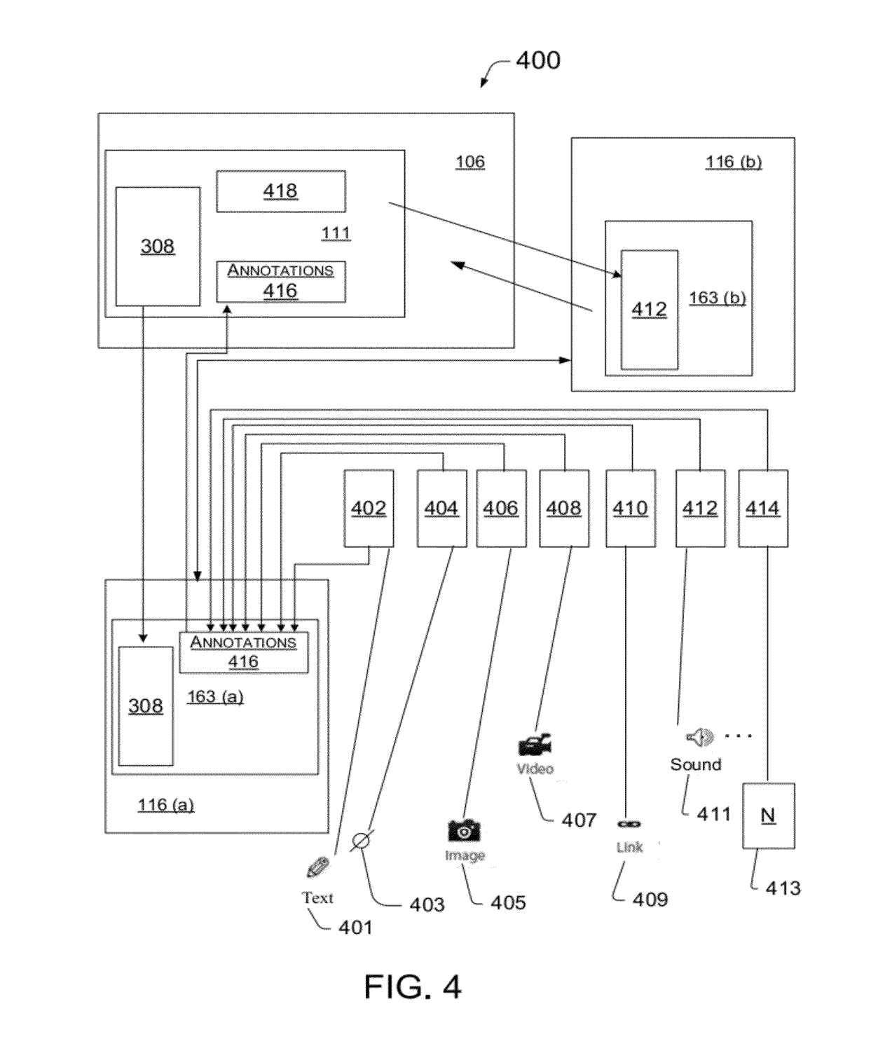

The index 316 is searchable. In certain embodiments, the index 316 allows searches of individual virtual objects without having to search the electronic document from which the virtual object was abstracted. To illustrate, if a first user utilizes a first user computing device 116(a) to request a search for “orthopedic video”; the host computing device 106, searches the index 316 using the search query “orthopedic video” to find the match computer readable file 308. Here, the host computing device 106 need not search the entire electronic document to find the match “orthopedic video.” Similarly, the host computing device 106 need not search an index associated with the entire electronic document, which might not have any keywords or data associated with the orthopedic video embedded in the electronic document that matches the query. Referring to FIG. 4, when a match is found, the first user is provided the matching computer readable file and/or corresponding virtual object. For example, the computer readable file 308 is sent to the user computing device 116(a) that is, in turn, encoded in the non-transitory computer readable medium 163(a). In certain embodiments, the user computing device 116 is disconnected from the communication fabric 114 (such as when the user is on an airplane and the communication are disconnected). Here, the user computing device 116 has access to the computer readable file 308, corresponding virtual object 307, and/or the electronic document and is capable of displaying same.

Access to the matching computer readable file depends on an access right of the user. For example, a client managing a client library dictates which users have access to corresponding computer readable files, virtual objects, electronic documents, and/or indices stored in association with the client library of the client. In the above example, if the first user requesting access to a computer readable file stored in association with a client library does not have access rights given by the client, then the first user will not be provided the corresponding requested computer readable files, virtual objects, electronic documents, and/or indices. Alternatively, if the first user requesting access to a computer readable file stored in association with a client library does have access rights given by the client, then the first user will be provided the corresponding requested computer readable files, virtual objects, electronic documents, and/or indices. To illustrate, if the client is a trade association, and a user that is a nonmember of the trade association requests a trade journal, the user will be denied access to the trade journal or its component virtual objects. In another example, if a corresponding electronic document or virtual object is for sale, the user does not have access rights until the user purchases electronic document or virtual object. the In certain embodiments, the host computing device 106 verifies the user's access rights by accessing a client's database of authorized users.

In certain embodiments, one or more users annotate the electronic document and/or its associated virtual objects with annotations, which are themselves virtual objects. In FIG. 4, the user computing device 116 (a) annotates the video object 308 with annotations 416. The annotations 416 are illustrated as: a text object 401, a null object 403 (e.g., redacting a video frame), a image object 405, a video object 407, an interactable graphic object 409, a sound object 411, and a Nth virtual object 314.

For example, the first user requests access to the video object 204 (FIG. 2) that is a video of a pediatrician conducting an exam on a child, originally embedded in the electronic document 200. The associated computer readable file, such as computer readable file 308 (FIG. 3), is sent to the user computing device 116(a) of the first user. The first user then uses computing device 116(a) to draft annotations that include: a textual comment “informative video for diagnosing heart murmurs”; a hyperlink to a website of a company selling the stethoscope used in the video; a graph illustrating a frequency of false positives and false negatives heart murmur diagnosis among pediatricians; and a sound file of a stethoscope recording of a heart murmur.

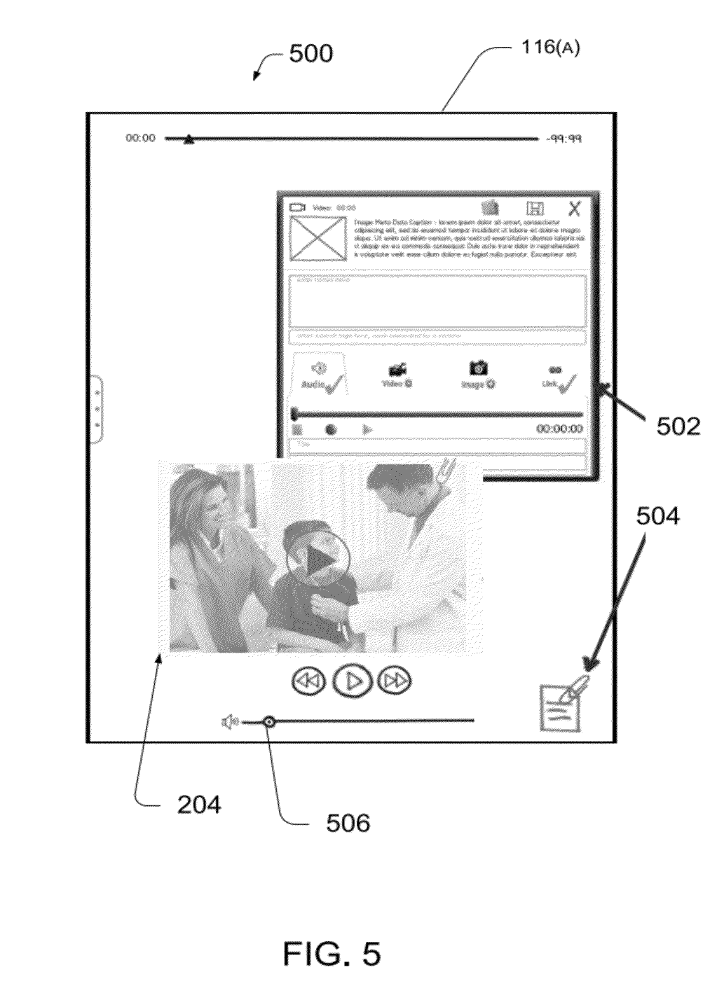

In certain embodiments, the user further indicates portions of the virtual object that are to be associated with respective annotations. In the example above, and referring to FIG. 5, the user attaches the sound file of the heart murmur at a specified frame 506 of the video corresponding to the video object 204. Here, the user interface 500 rendered on the user computing device 116(a) displays the video object 204 and its corresponding frames. The user selects the option 504 to include a sound file in association with the video object 204. A pop up window 502 opens with tools for recording and/or uploading the sound file, which is then associated with the specified frame 506 of the video. Metadata for the annotation includes data about the annotation, such as the frame number of the video, a description of the sound recording, the name of the first user that uploaded the sound recording, and the like.

Referring back to FIG. 4, the user sends each of the annotations and/or corresponding metadata to the host computing device 106. For example, the host computing device 106 receives the annotation associated with a (j)th virtual object (video object 307), wherein (j) is less than or equal to (N), which is the number of total virtual objects in the electronic document. The host computing device 106, in turn, encodes the annotation and the corresponding annotation metadata in the non-transitory computer readable medium 111 in association with the computer readable file 308. The host computing device 106 creates an index 418 referencing the annotations, which is searchable. In certain embodiments, the index 418 is encoded in association with one or more of the client library and a user library for the first user.

In certain embodiments, the first user shares one or more of the electronic documents, corresponding virtual objects, corresponding computer readable files and/or corresponding annotations with a second user. In the above example, the user requests to share, the sound recording of the heart murmur with a second user that has the user computing device 116(b). The host computing device 106, in turn, sends to the second user the associated sound object computer readable file 412, based on the access rights of the second user. For example, the host computing device 106 validates the second user as a member of the professional association of the client prior to sending the computer readable file 412 that was encoded in the client library of the professional association.

In certain embodiments, the first and second users interchange data, either through the host computing device 106 or directly regarding the electronic document, corresponding virtual objects, corresponding computer readable files and/or corresponding annotations. For example, the users exchange annotations, or converse through a “chat” environment, about regarding the electronic document, corresponding virtual objects, corresponding computer readable files and/or corresponding annotations. For example, the non-transitory computer readable mediums 163(a) and 163(b), respectively of the user computing device 116(a) and 116(b) each have encoded Applicants' computer readable program code 164(a) and 164(b). The encoded program code 164(a) and 164(b) allows them to communicate with one another regarding the electronic document, corresponding virtual objects, corresponding computer readable files and/or corresponding annotations.

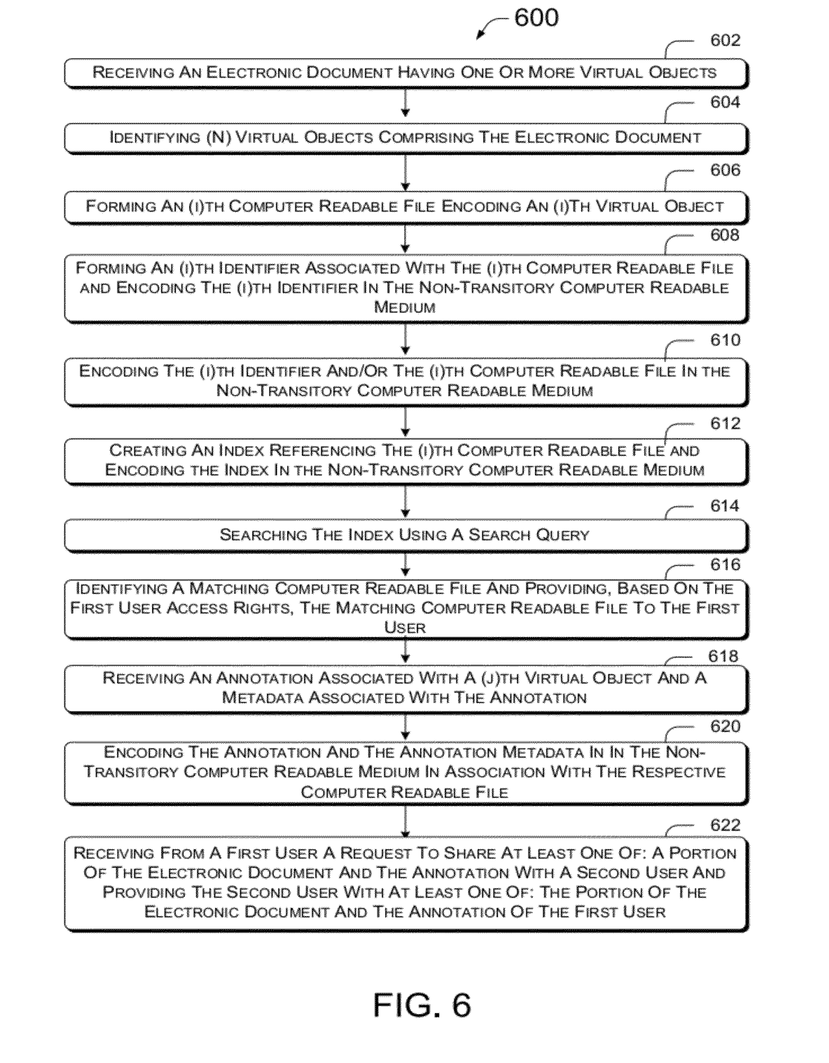

Referring to FIG. 6, a method 600 for providing remote access to virtual objects abstracted from an electronic document is illustrated. At step 602, an electronic document having one or more virtual objects is received. For example, a publisher accesses a website of the host and sends the host computing device 106, a ZIP file including a Portable Document Format (PDF) file. The PDF has one or more virtual objects, such as a text and an image, with internal and/or external associated metadata. The metadata has data describing the fixed-layout of the electronic document, including the text, fonts, graphics, and other information needed to display the PDF, for example. In another example, the user uploads a word document containing one or more virtual objects and corresponding metadata that the user wants associated with the user library of the user. The user library is a library specific to the user in which only the user has access rights unless the user authorizes others to have access rights.

At step 604, the host computing device 106 identifies the virtual objects comprising the PDF. For example, corresponding metadata is used to identify the respective virtual objects comprising the PDF. If the publisher has requested that the PDF file be associated with a client library of a client, the host computing device 106 requests authorization from the client to associate the PDF with the client library. To illustrate, the client accesses an account of the client via a website of the host computing device 106. The website includes an alert that a publisher wishes to associate a PDF document with the client's client library. The client reviews the PDF and determines whether to provide or decline authorization. If the client declines authorization method 600 is terminated for that publisher. Alternatively, if the client provides authorization, or a user is merely uploading a document to a user library which does not require client authorization, method 600 moves from step 604 to step 606.

At step 606, the host computing device 106 forms corresponding computer readable files encoding the respective virtual objects. At steps 608 and 610, corresponding identifiers for the respective computer readable files are each formed and encoded, along with the corresponding computer readable files, in non-transitory computer readable medium 111. At step 612, the host computing device creates an index referencing the corresponding computer readable files and encodes the index in the non-transitory computer readable medium 111.

At step 614, the host computing device 106 searches the index using a search query. For example, a client uses an API stored on the client computing device 102 to access the PDF encoded in association with the client library. The client, in turn, requests a search and inputs the search query. Alternatively, the user utilizes an API stored on the user computing device 116 to access the host computing device 106 and requests the search. At step 616, the host computing device 106, in turn, conducts the requested search using the search query and identifies a matching computer readable file that is then provided to the query maker. In certain embodiments, the matching computer readable file is provided to those with access authority, such as members of a professional organization that manages the corresponding client library.

At step 618, the host computing device 106 receives an annotation to one or more virtual objects of the PDF. For example, a user uses the API on the user computing device 116 to create a sound file commenting on a text object. The sound file annotation is, in turn, sent to the host computing device 106. In certain embodiments, the annotation has a respective metadata which is also sent to the host computing device 106.

At step 6202, the received annotation and corresponding metadata are encoded in the non-transitory computer medium 111 in association with the respective computer readable file (the text object in the above example). At step 622, the user requests to share the electronic file and/or annotation with another user. The host computing device 106 provides the electronic file and/or annotation to the other user based on, for example, the access rights of the other user. To illustrate, if the other user is not a member of the professional association managing the client file the PDF is encoded under, the other user will be denied access.

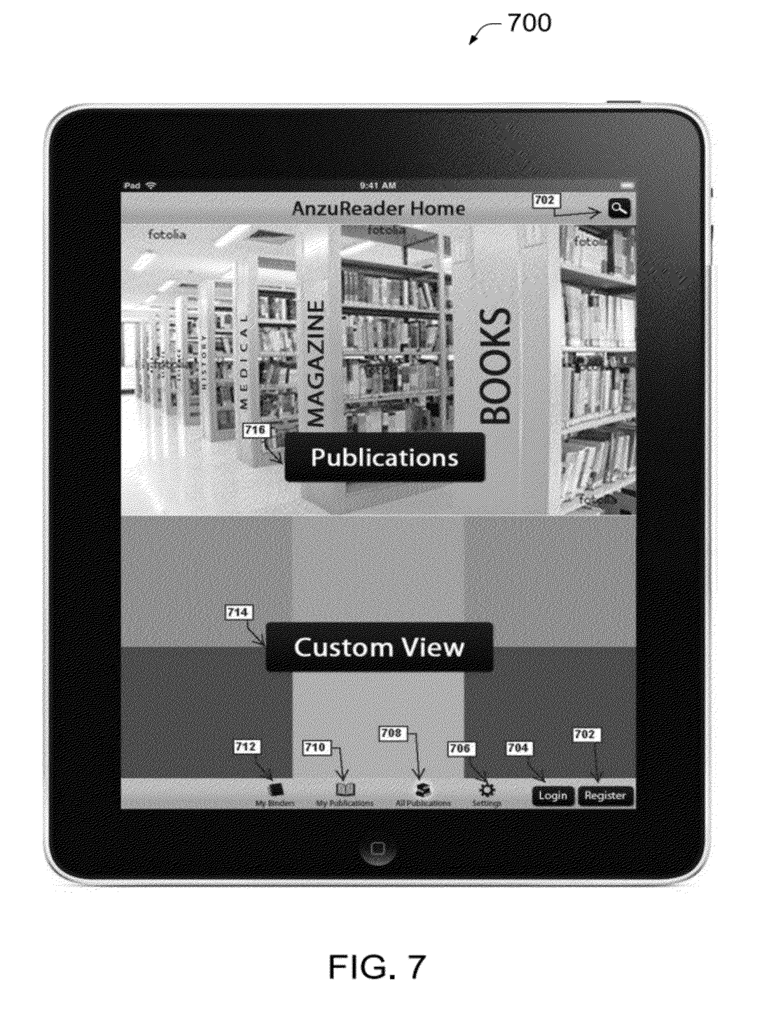

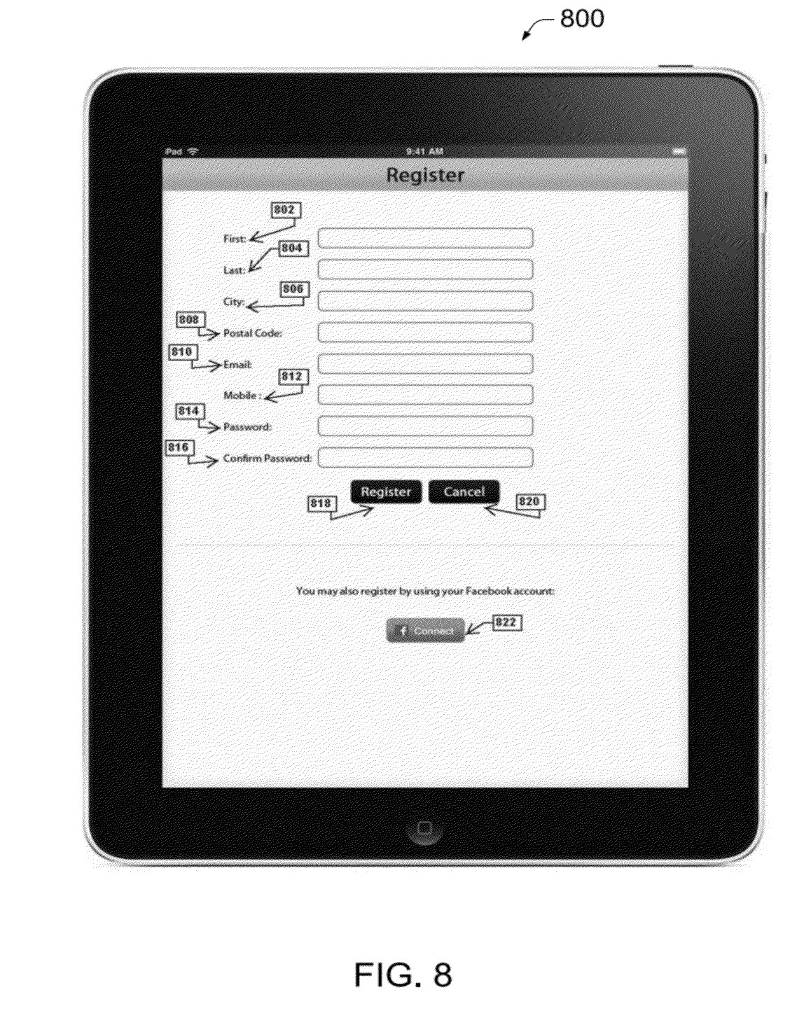

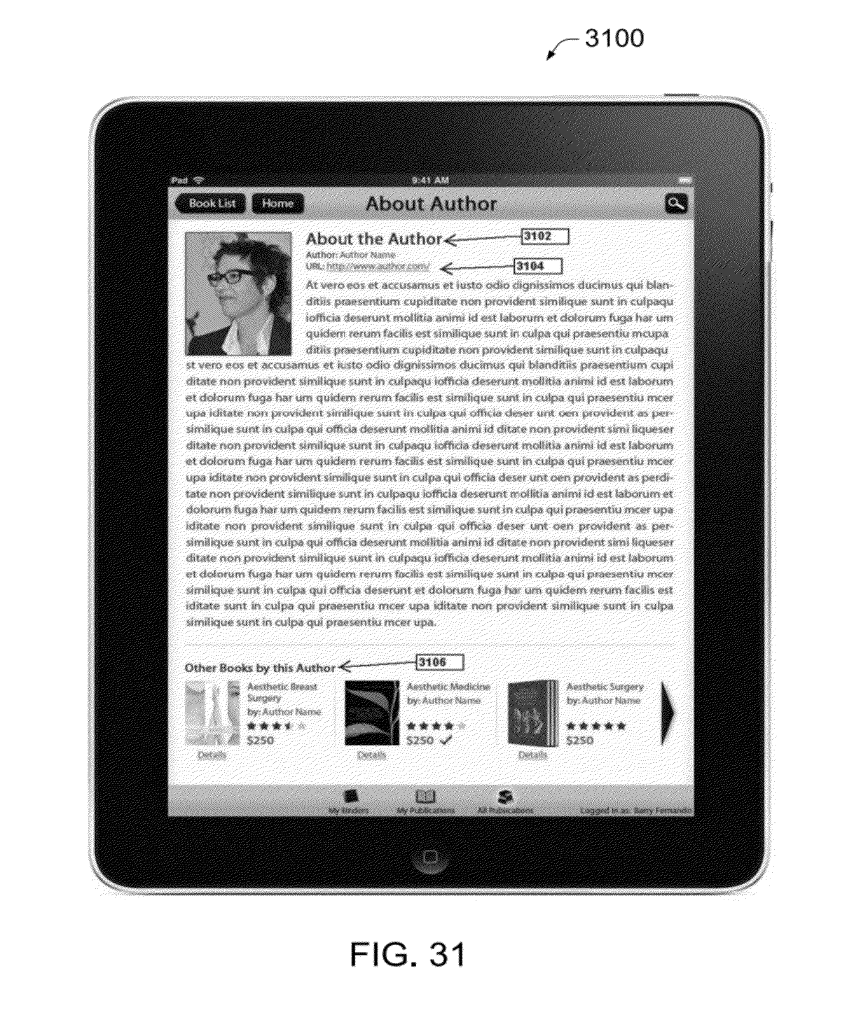

Referring to FIGS. 7-31, screen shots illustrate exemplary user interfaces (UI) that are each rendered by a computing device, such as the user computing device 116. In FIG. 7, a home UI 700 is illustrated. Here, the user has the ability to select buttons with corresponding functionalities. For example, a new user selects Register button 702 to register as a user with membership access to the electronic content saved within the data repository 118. Referring to FIG. 8, a Registration UI 800 illustrates a plurality of data entry boxes, such as: a first name data entry box 802, a last name data entry box 804, a city data entry box 806, a postal code data entry box 808, an email data entry box 810, a mobile number data entry box 812, a password data entry box 814, and a confirm password data entry box 816. Alternatively or in addition, the user imports the user profile from another application, shown as a social networking site profile import button 822. Upon completion of entering data the user registers as a member of the system 100 by selecting register button 818 or terminates the session by selecting cancel button 820.

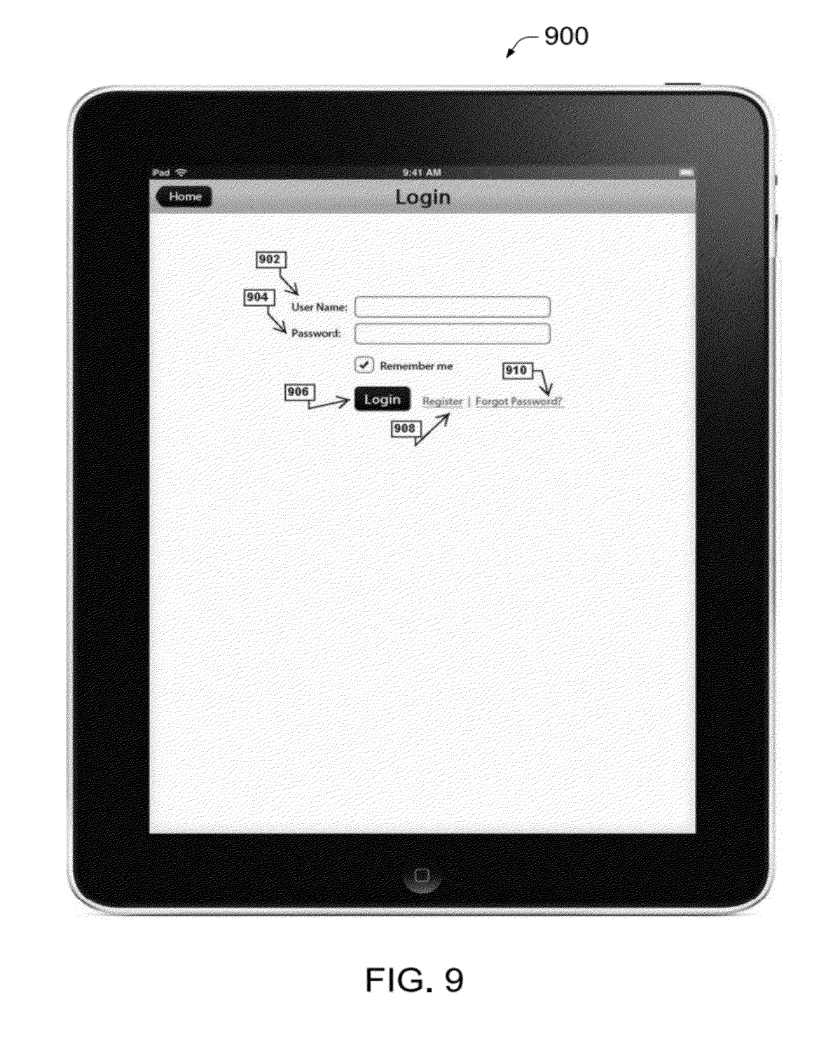

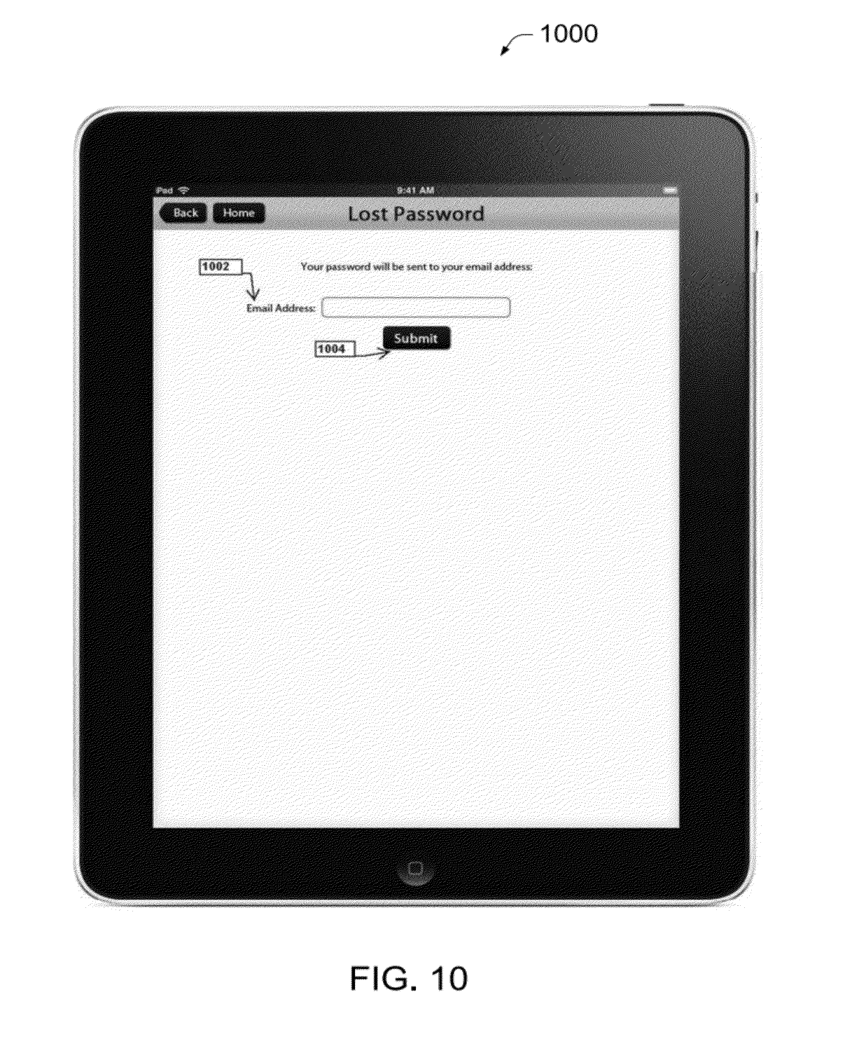

Referring back to FIG. 7, a user that has already registered can login by selecting button login 704, which leads to a Login UI 900 of FIG. 9. Here, the user enters a username in data entry box 902, a password in data entry box 904 and logs on by selecting login button 906. If the user does not have a username and password, the user selects Register link a 908, which leads to registration UI 800 of FIG. 8. If the user has forgotten the user's password, the user selects Forgot Password link 910, which leads to Lost Password UI 1000 of FIG. 10. Here, the user enters in e-mail address 1002 and selects Submit button 1004 to send the email address to the host computing device 106. If the entered email matches the email entered in email data entry box 810 of FIG. 8, the password is emailed using the entered email address of the user.

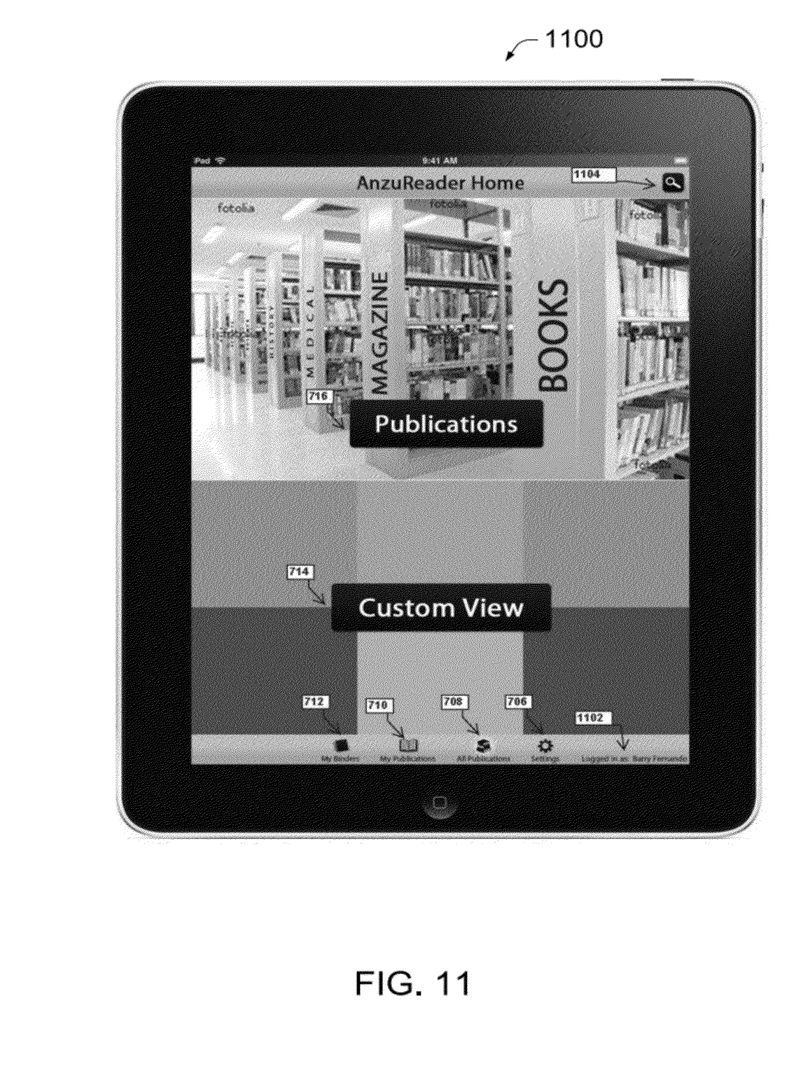

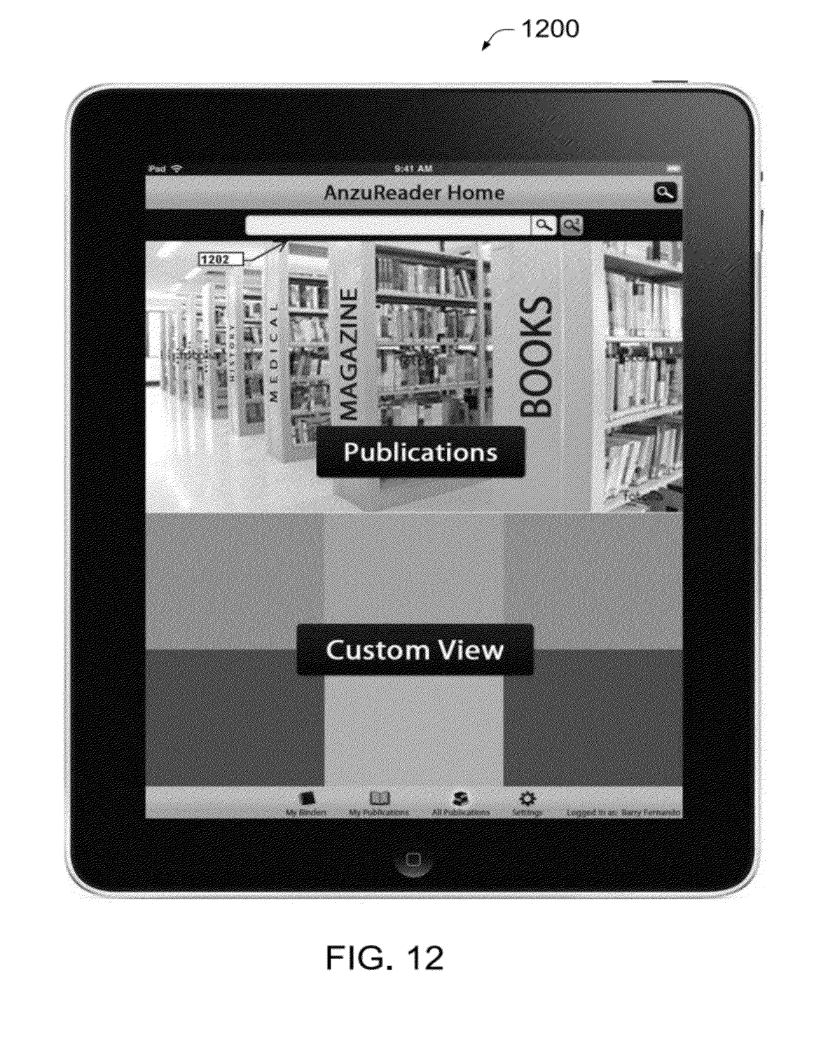

Once logged in, the computing device renders the Logged in UI 1100 of FIG. 11. As with Home UI 700 of FIG. 7, the user has the ability to select buttons with corresponding functionalities. Here, the user sets or edits the settings by selecting Setting button 706, renders data about all publications by selecting All Publications button 708, renders data for select publications by selecting My Publications button 710, or renders data about previously selected portions of publications by selecting My Binders button to 712. The user also has the option to view all publications via Publications button 716 or to view specialized libraries via Custom View button 714, each of which leads to corresponding user interfaces. The user selects search button 1104 to search for publications or other data. Search button 1104 opens a search query box, such as quarry box 1202 in Logged in UI 1200 of FIG. 12.

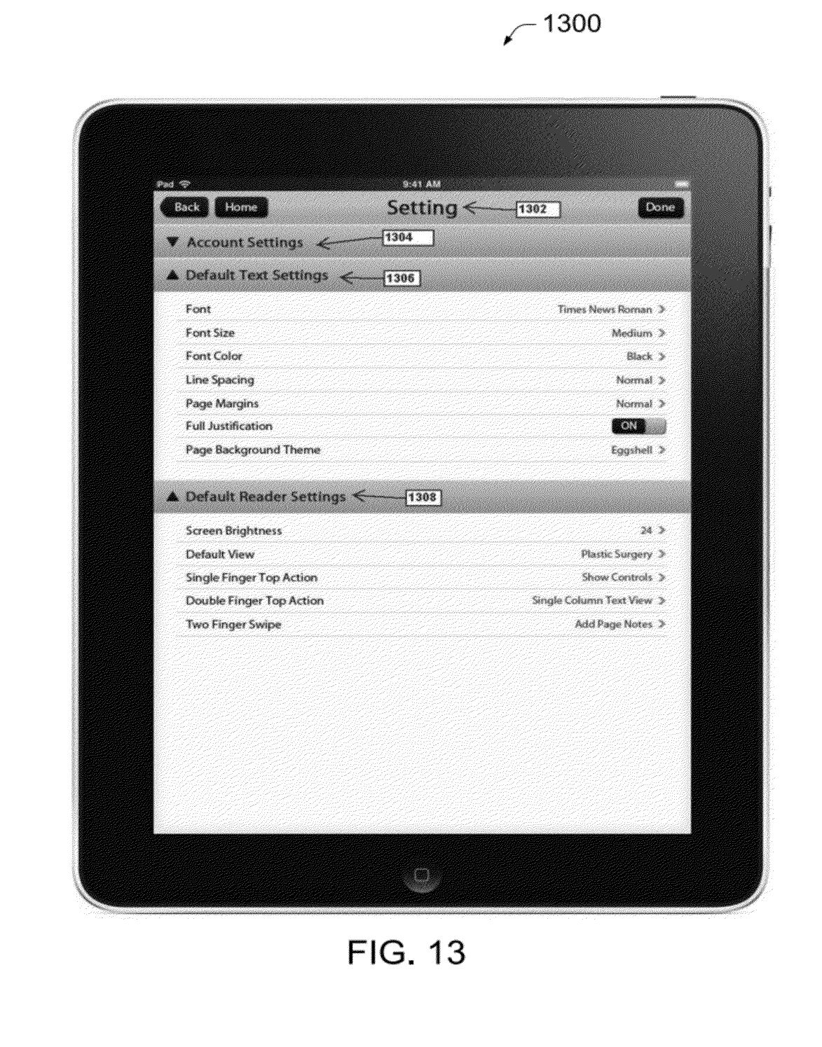

Referring to FIGS. 11 and 13, when the user selects settings button 1104, a Setting UI 1300 of FIG. 13 is rendered on the computing device. Here, the user selects settings 1302, such as account settings 1304, the full text settings 1306, or default reader settings 1308.

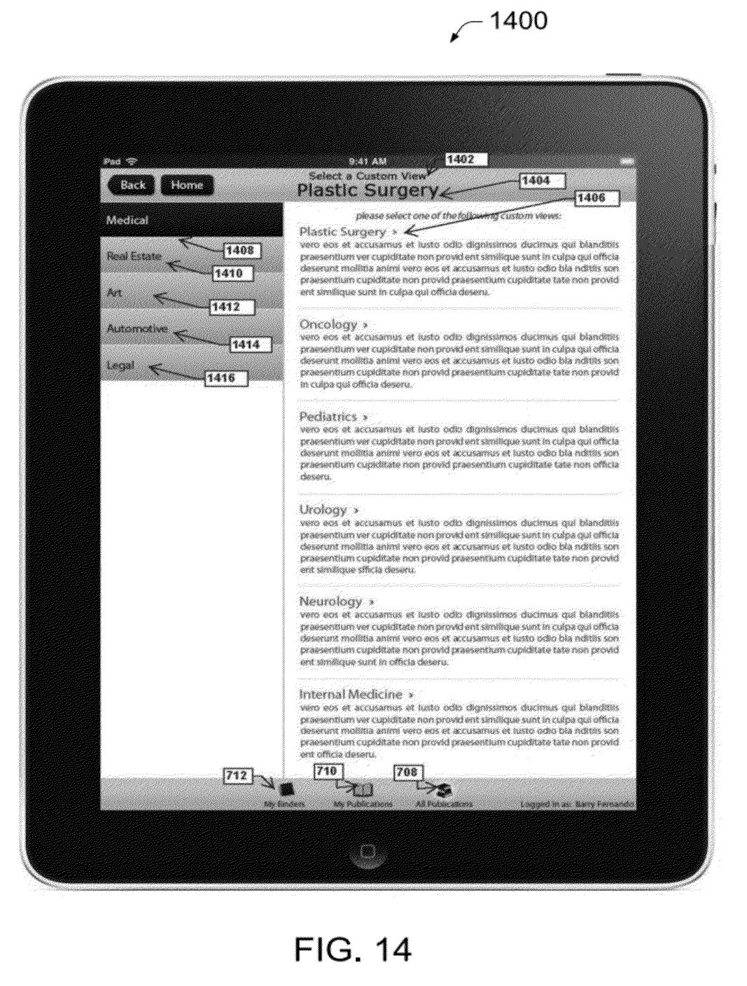

Referring to FIGS. 11 and 14, the user selects Custom View button 714, which leads to a Custom View Library UI 1400 of FIG. 14. In the embodiment illustrated in FIG. 14, the user has access to a plurality of specialized virtual libraries, such as a medical virtual library 1408, a real estate virtual library 1410, an art virtual library 1412, an automotive virtual library 1414, or a legal virtual library 1416, each of which has its own respective electronic content/document that can be organized in subcategories. To illustrate, the medical virtual library 1408 includes a plurality of selectable custom views 1402, such as plastic surgery custom view 1404, which is selected by selecting plastic surgery link 1406.

In certain embodiments, specialized virtual libraries are created by the client and/or the user. To illustrate, the client the American Society of Aesthetic Plastics Surgery (ASAPS) creates the plastic surgery virtual library 1404 that is, in turn, accessible to users that are members of the American Society of Aesthetic Plastics Surgery via plastic surgery links 1406 rendered on corresponding user computing devices 116.

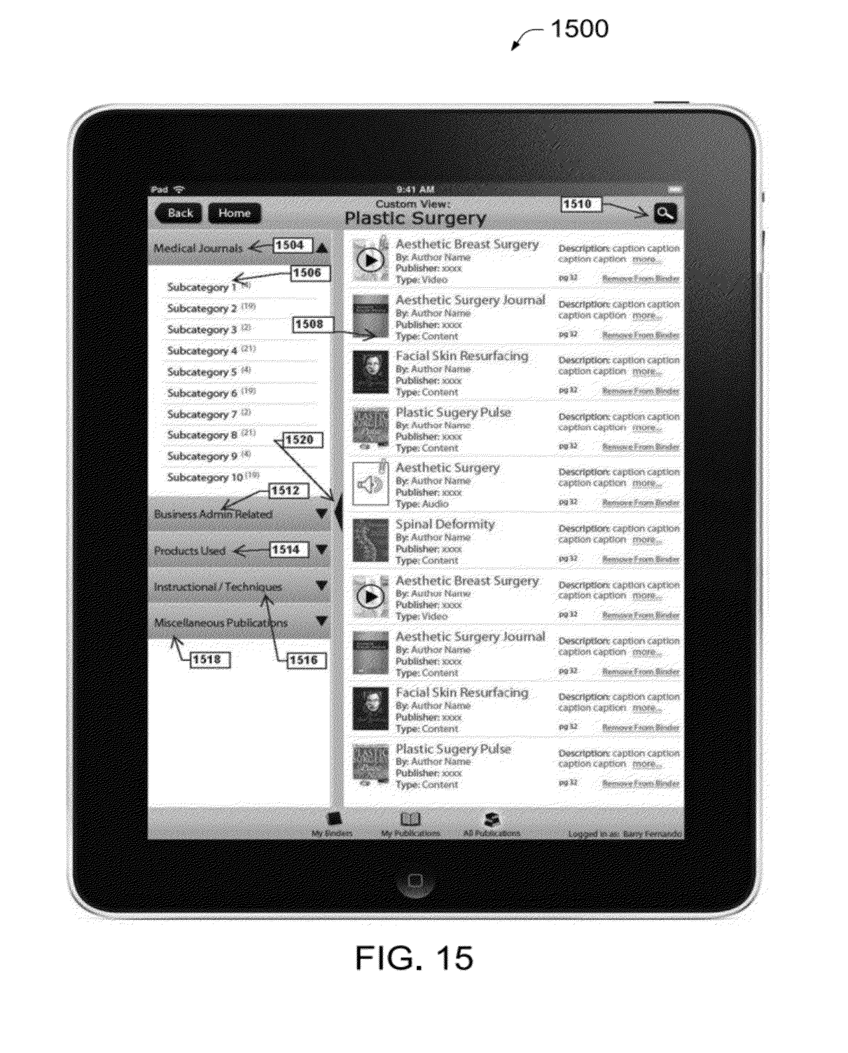

Referring to FIG. 15, a Plastic Surgery Custom View UI 1500 is illustrated. In this illustrated example, the ASAPS has created subcategories of electronic content: Medical Journals 1504, Business Admin Related 1512, Products Used 1514, Instructional/Techniques 1516, and Miscellaneous Publications 1518. Each of the subcategories, in turn, includes electronic content that the ASAPS deems relevant for its members. In certain embodiments, the user conducts a search for other relevant electronic content for the Plastic Surgery virtual library via search button 1510.

In certain embodiments, Products Used 1514 leads to data about instruments, apparatuses, or pharmaceuticals, that are recommend or used within the field of plastic surgery. For example, manufactures of medical instruments or pharmaceuticals are publishers that provide brochures, product ratings, product alerts, and contact information to the host computing device 106 that is then associated with the corresponding client library. The host computing device 106 implements code to store the data received from the publisher in the data repository 112 in association with the Plastic Surgery virtual library that is accessible to users via the Products Used 1514 link of FIG. 15. The products used data is updated as new information becomes available. Consequently, the user has access to up-to-date data from the corresponding manufacturers. Comments and recommendations regarding the instruments or pharmaceuticals from other members of ASAPS or the ASAPS can also be accessed via the Products Used 1514, such as through blogs, chats, or other member's notes that are annotations to virtual objects associated with the Products Used 1514 virtual library of virtual objects.

In certain embodiments, the data accessible via Products Used 1514 is tailored to the user. For example, if members of the ASAPS that live in a 85028 area code utilize a first manufacturer's instruments more frequently than one made by a second manufacturer, then data about the first manufacture's instruments may appear first in a list of instruments rendered to the user. Other user tailored content is also contemplated, for example, a date range for a future visit from the manufacturer's representative is rendered to a user. Here, the Products Used UI (not shown) allows scheduling of a visit from the representative with the user, interactive Q/A between the user and the representative, or the user may request particular presentations from the representative.

Referring back to FIG. 15, Medical journals 1504 is broken up into further subcategories 1506. As illustrated in FIG. 1500, detail information about the medical journals 1504 is also provided. For example, for each of a plurality of journals, data is provided that includes: the title of the journal, an author of the journal, a type of journal, a description of the journal, and a number of pages for the journal is provided, for example.

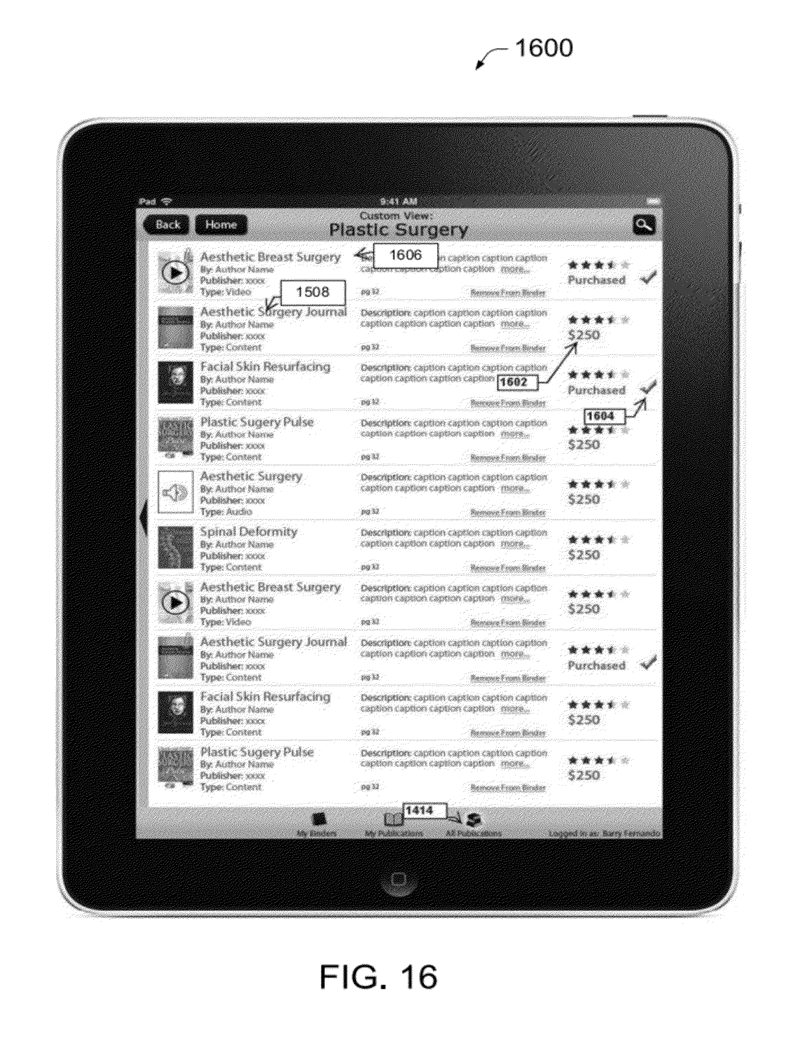

Further data about the Medical Journals 1504 is accessible by selecting slide out drawer 1520, which leads to a Custom View UI 1600 of FIG. 16. Here, journals that have been previously purchased or subscribed to are indicated by a check mark 1604. For journals that have not been purchased or subscribed to, the price of the journal is indicated, such as price 1602 for the Aesthetic Surgery Journal 1508. The entire journal, or portions thereof may be purchased. For example, if the user wishes to purchase a single article (article virtual object) within the Aesthetic Surgery Journal 1508, then the user may select the corresponding link to be lead to a UI for purchasing content from the Aesthetic Surgery Journal 1508.

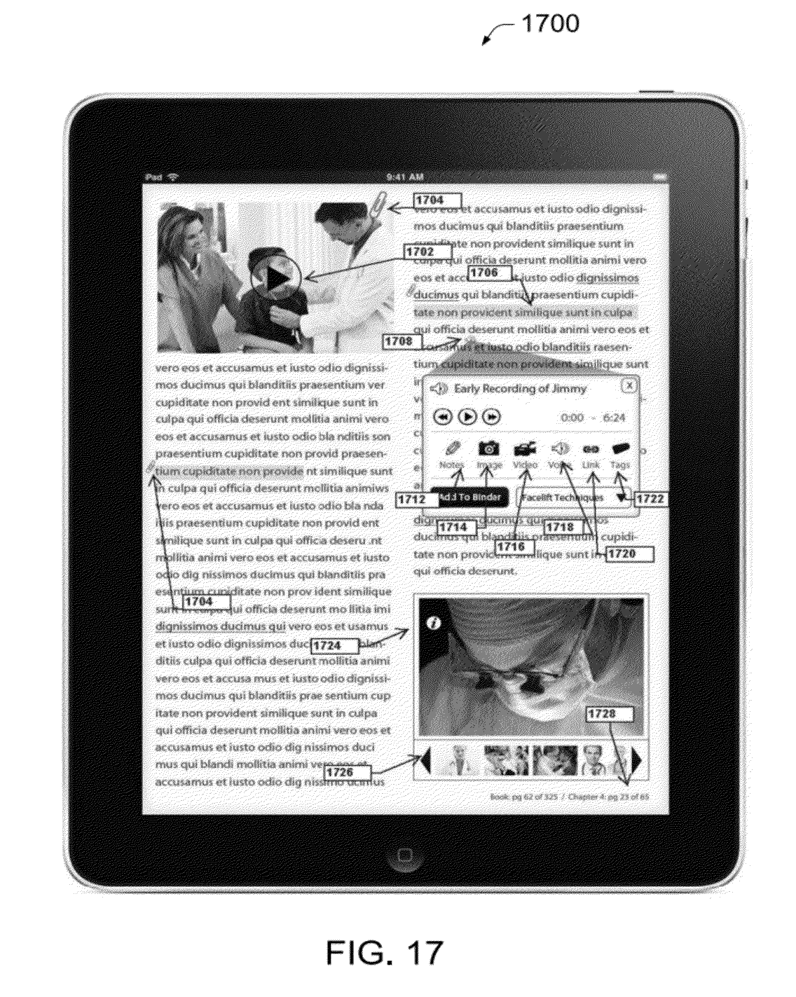

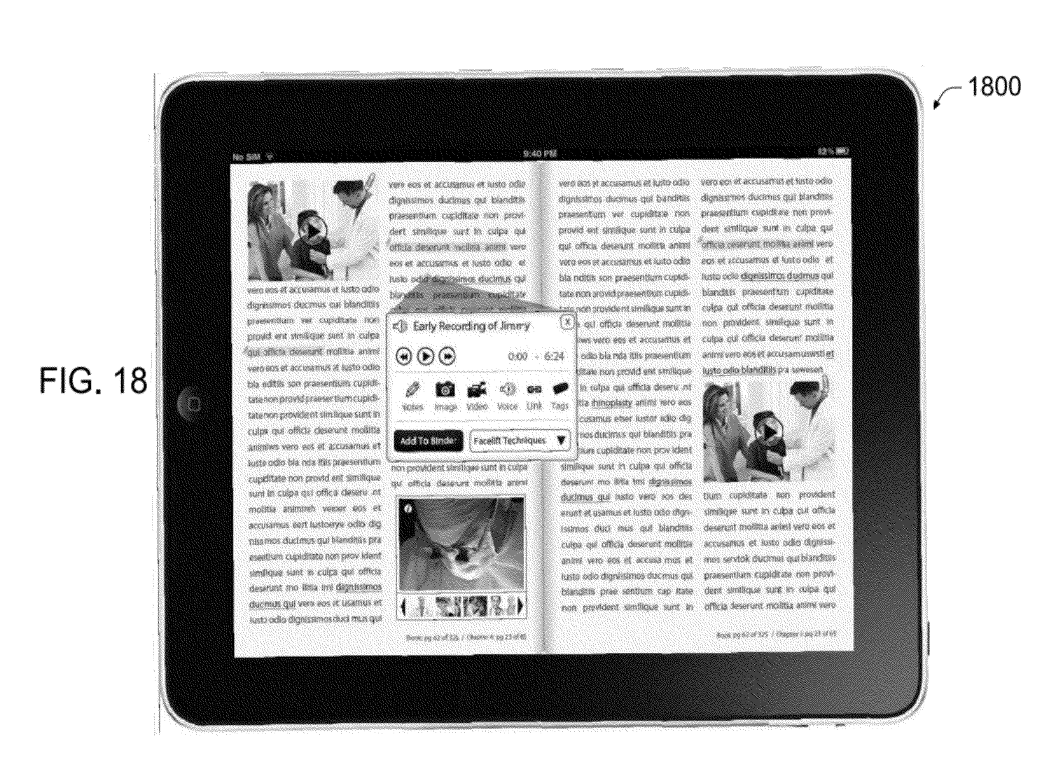

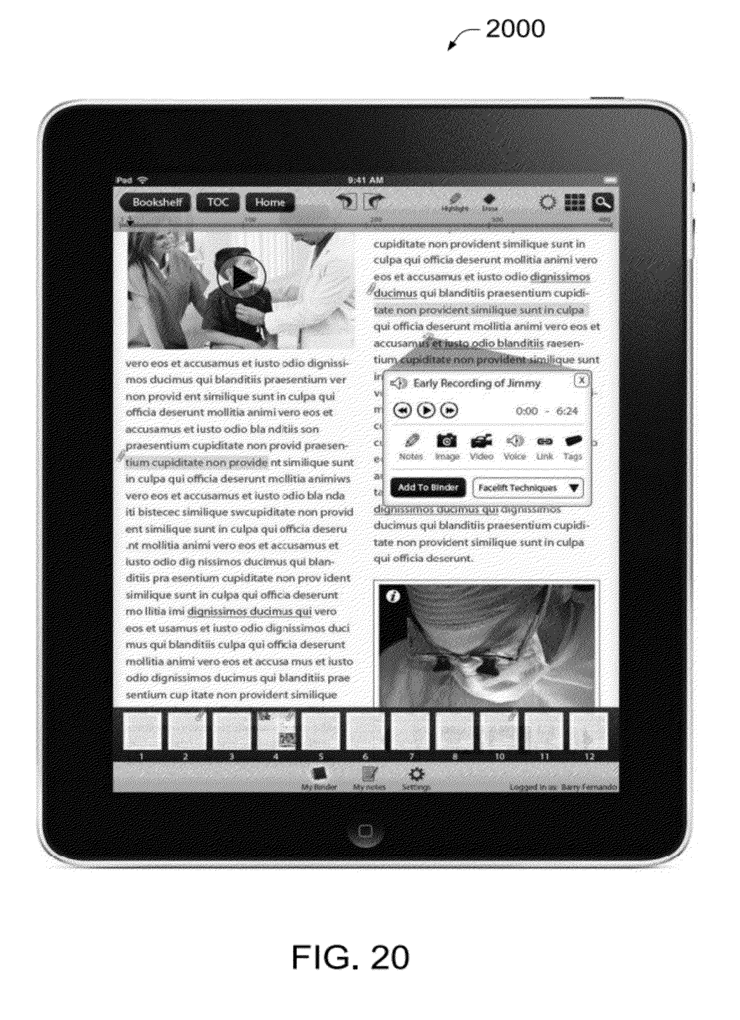

Referring to FIGS. 16 - 19, if the user selects the subscribed to Aesthetic Breast Surgery journal 1606, the user is lead to Multimedia Content UI 1700 for the Aesthetic Breast Surgery journal depicted in FIGS. 17 and 20 (single page format) and FIG. 18 (book format with two page rendition). Other renditions are also contemplated. For example, in certain embodiments, page 62 of the journal 1728 is rendered in a single column format (not shown).

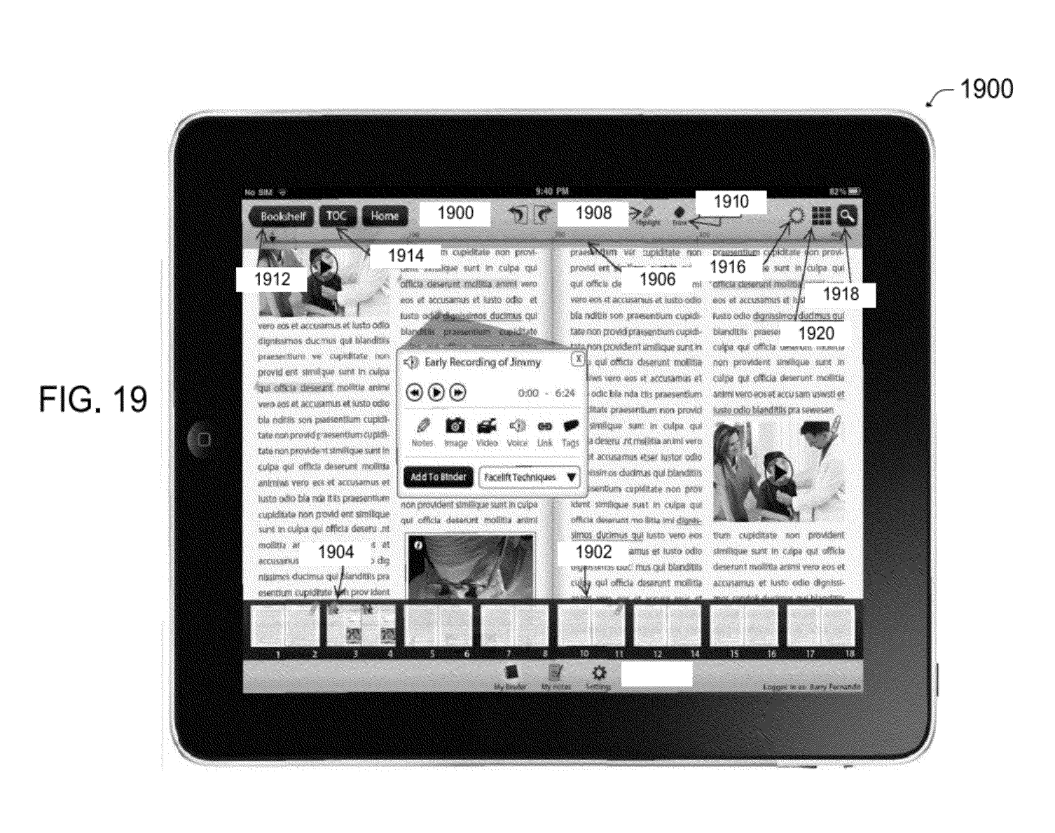

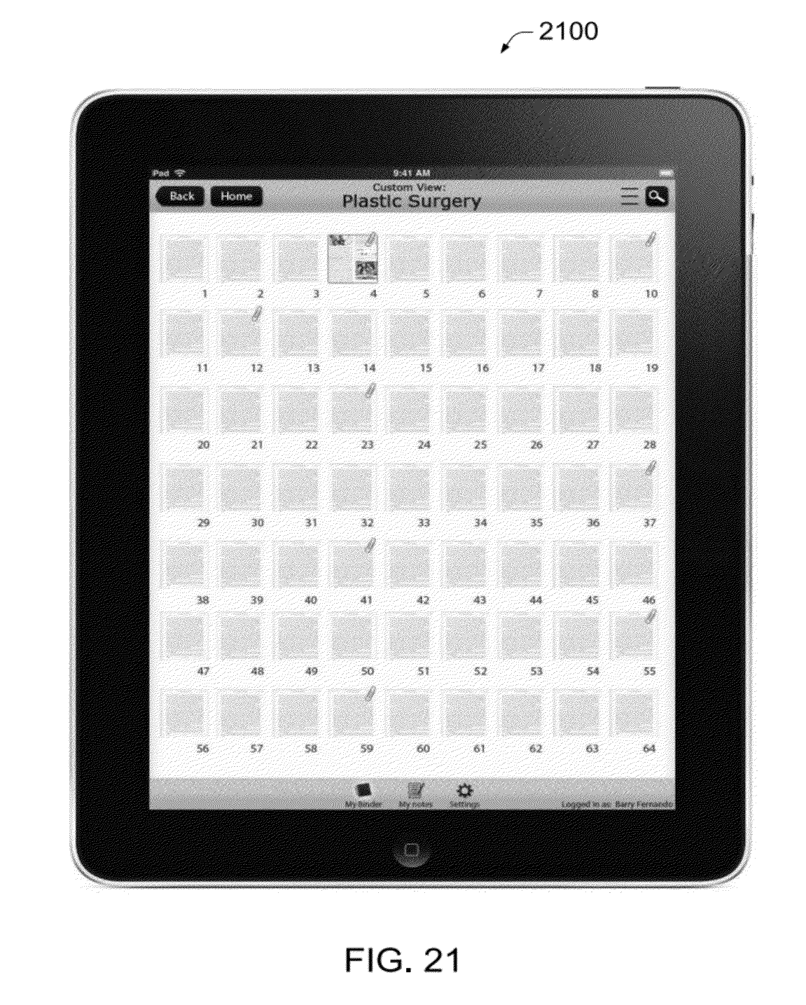

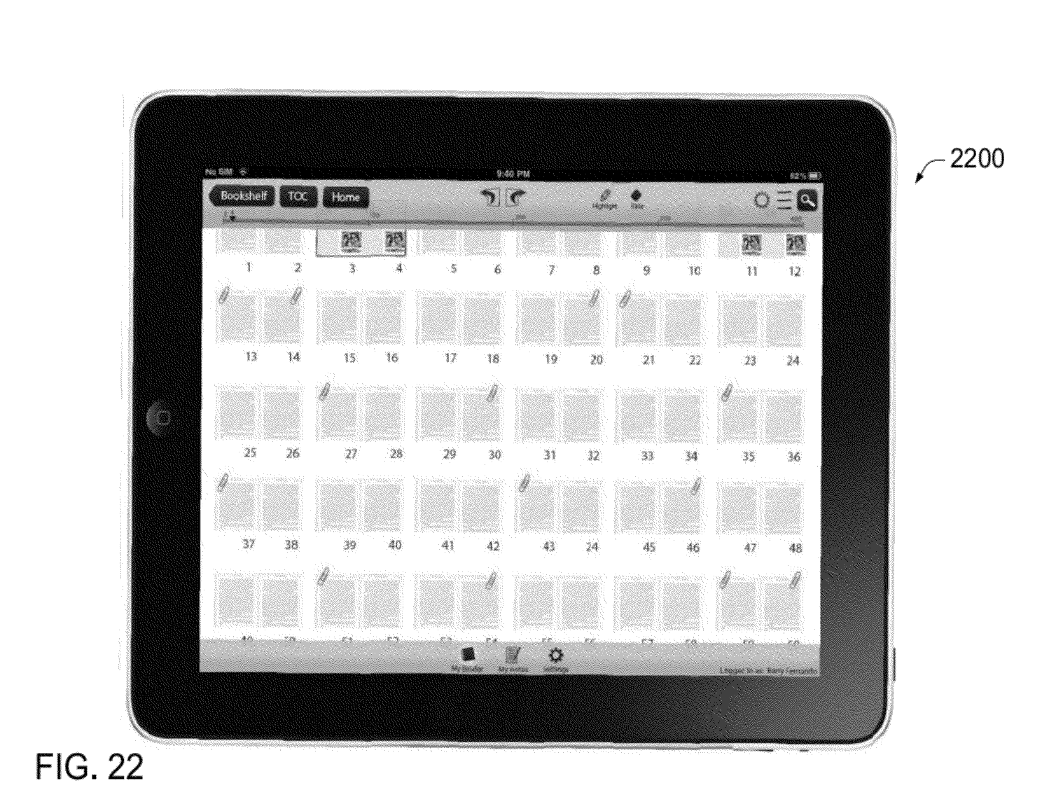

In the example depicted in FIG. 17, the user has access to multimedia content related to the Aesthetic Breast Surgery journal article, such as an instructional video 1702 or product content via option 1724. Comments from others about the article is also accessible via link or scroll bar 1726. The table of contents of the journal is accessible via the TOC button 1914 of FIG. 19 and the entire bookshelf with related journals is accessible via Bookshelf button 1912. A scroll bar 1906 on top of the Multimedia Content UI 1900 shows the location of the currently rendered page within the journal. A scroll bar 1902 at the bottom of the Multimedia Content UI 1900 shows thumbnails of the page in relation to the other pages of the article and corresponding multimedia, such as paperclip 1904 that corresponds to the attached content 1704 of FIG. 17. The entire article or book can be viewed via link 1920, which leads to Multipage View UI's 2100 and 2200 of FIGS. 21 and 22, respectively.

In certain embodiments, the user annotates the electronic documents in a virtual library. Referring back to FIGS. 17 and 19, the user highlight portions of the article 1706 via a highlighter tool 1908 or removes highlights via erase tool 1910 of FIG. 19. In certain embodiments, the user dictates a note and attach the voice file to specific portions of the article as denoted by speaker button 1908 of FIG. 19. Here, the user can attach notes 1712, images or slide shows 1714, a video 1716, a voice file 1718, a link to other journal pages or a Uniform Resource Locator (URL) 1720, or tags 1722 with the selected portion 1708 of the journal article.

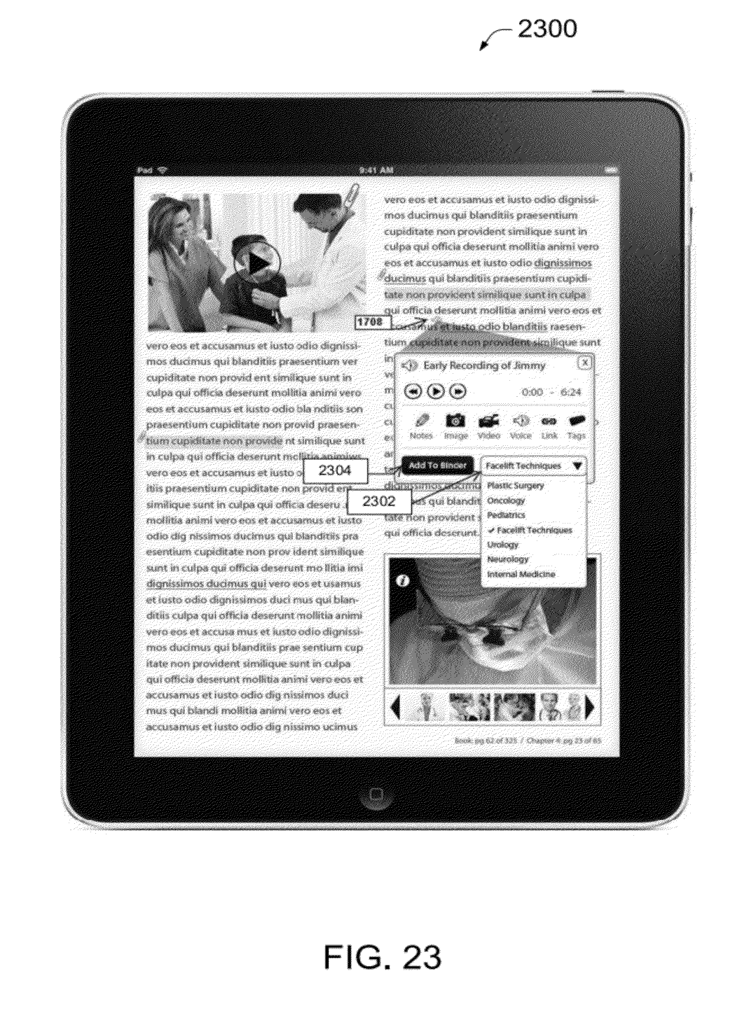

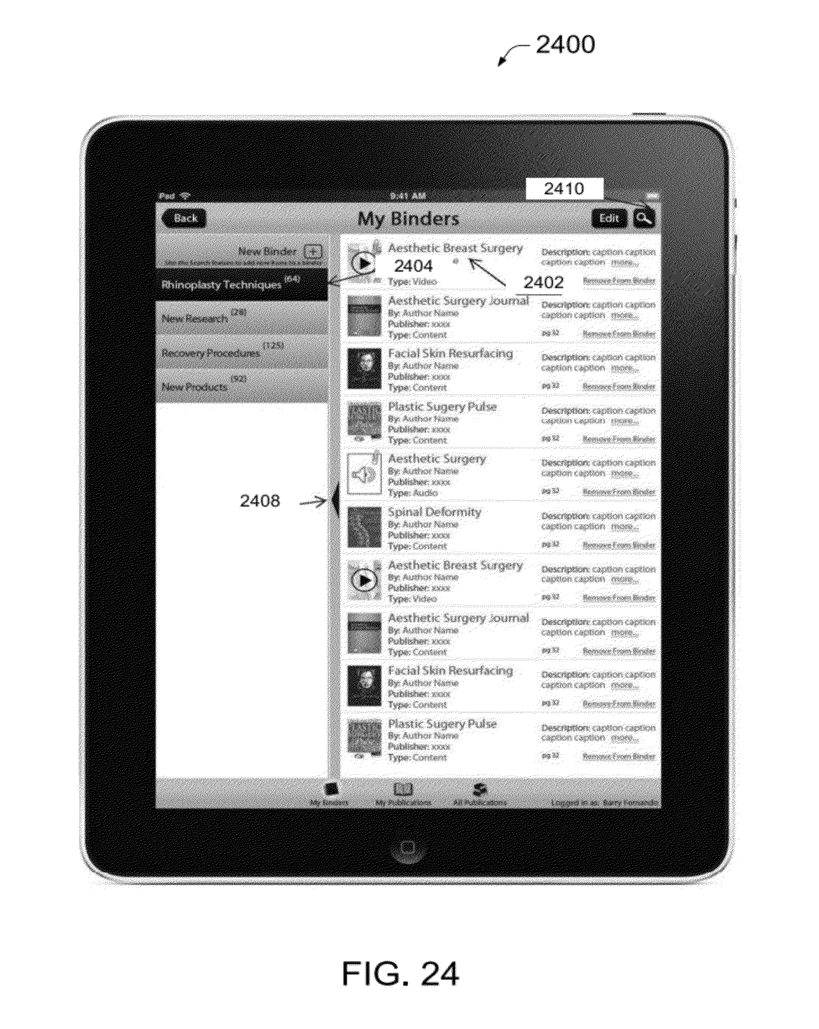

Referring to FIG. 23, in certain embodiments the user extracts electronic content from a plurality sources, such as of books or journals for example, and organize them into topical binders via pull down menu 2302. To illustrate, portions of the Aesthetic Breast Surgery journal article can be captured and stored in a binder via Add To Binder button 2304, which leads to My Binder UI 2402 of FIG. 24. Here, the user has added sections from the Aesthetic Breast Surgery journal article 2402, and/or corresponding annotations or multimedia, to the Rhinoplasty Techniques binder 2404. Analogous to tearing out a page from a book and storing it into a physical file folder, here, the user selects portions of interest from electronic content, organizing the portions into topical files, such as Rhinoplasty. To illustrate, if the user is interested in a certain technique and wants the latest information on that technique plus a video on how to do that technique plus previous articles written about that technique then the user would have easy access to all this information in one location via a binder. Moreover, because the selected content of the binder is saved within the data repository 118, the data is up-to-date. Therefore, if the technique is updated or criticized by the client that created the corresponding virtual library and linked to the section that was selected by the user to include in the binder, then the binder includes the update or criticism.

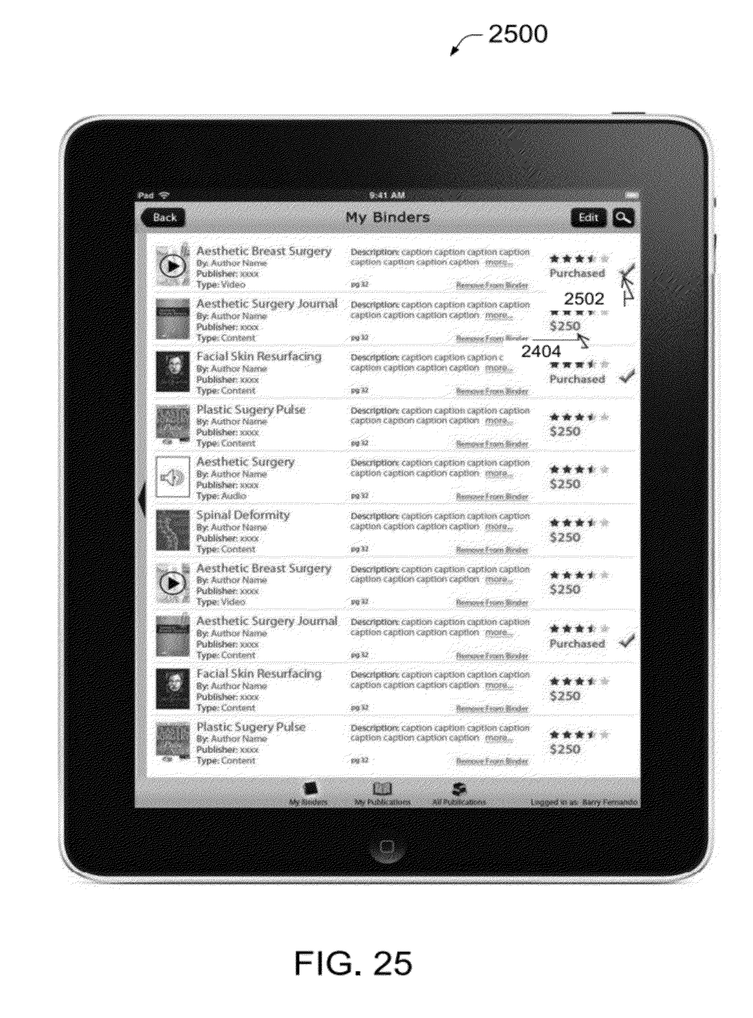

In FIG. 24, a pull out tab 2408 leads to Binder UI 2500 of FIG. 25. Here, the user accesses detail information about each electronic content in the corresponding binder. To illustrate, the Rhinoplasty Techniques binder 2404 includes a plurality of electronic content rendered by Binder UI 2500. In certain embodiments, the electronic content in the binder originated from a purchased 2502 item. Alternatively, in certain embodiments, the electronic content originated from an item that has not yet been purchased 2004. For example, the user may have attached a comment from another user about the Aesthetic Surgery Journal but not the journal itself, or the user may have received a free excerpt from the, as yet not purchased, journal and placed the excerpt in the binder.

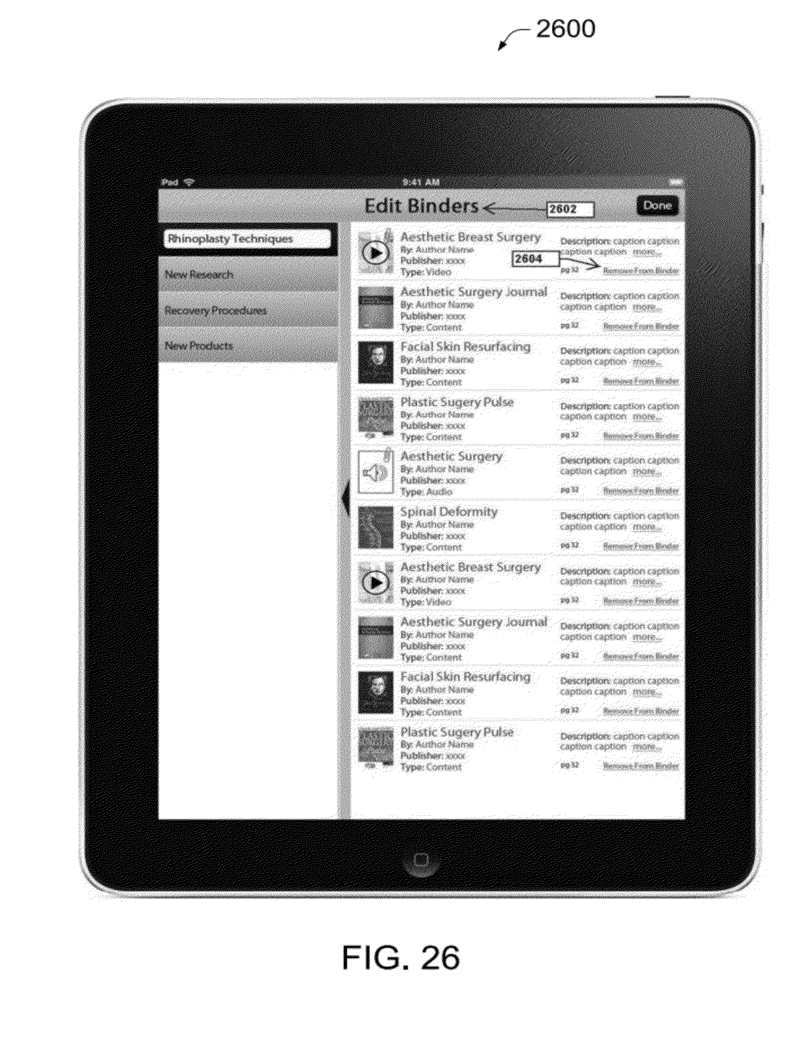

Referring to FIG. 26, the content of the binder is editable via the Edit Binder UI 2602. For example, the content can be removed from the binder via link 2604.

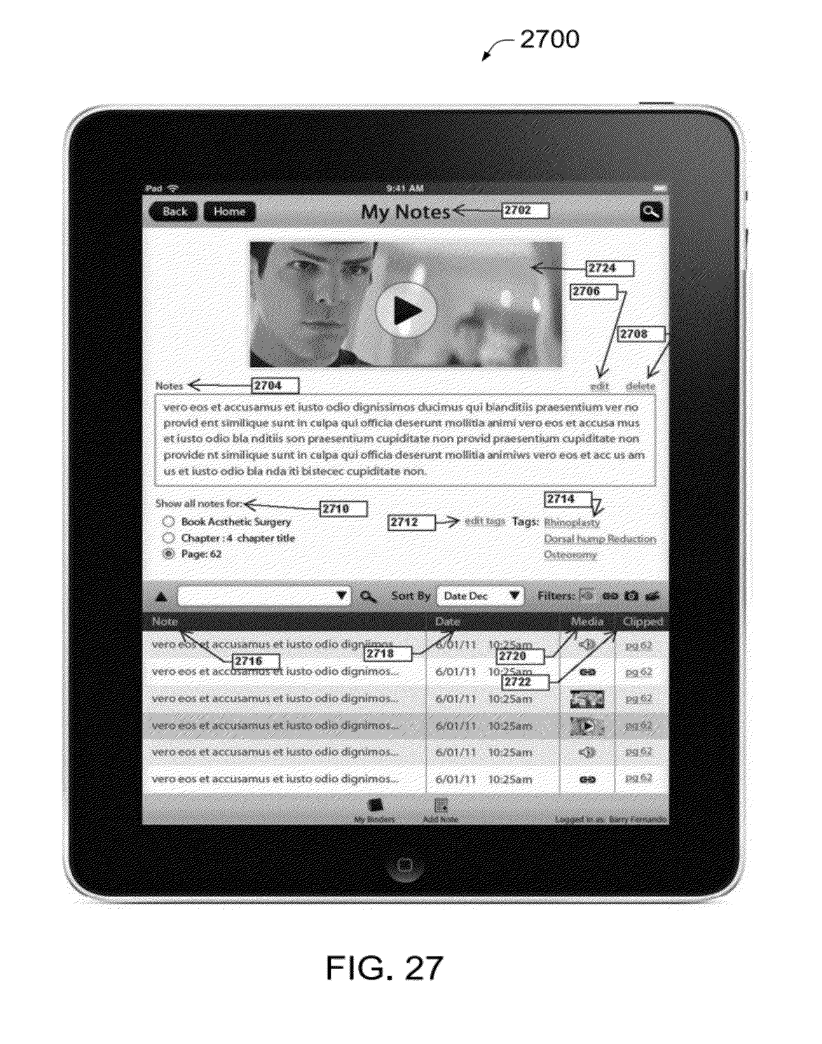

In certain embodiments, the user adds notes to the content in a binder. In FIG. 27, a My Notes UI 2702 provides notes options to the user. Here, the user adds text notes via Notes 2704 data entry box, edits the textual notes via edit link 2706, deletes the textual notes via delete link 2708, shows all notes via option 2710, edits tags via edit tag 2712 for various binders 2714, or adds a video 2724. The user also has access to a list of notes 2716 (annotations), the date of entry of the corresponding notes 2218, the media format of the notes 2720, and the page that was clipped into the note 2722.

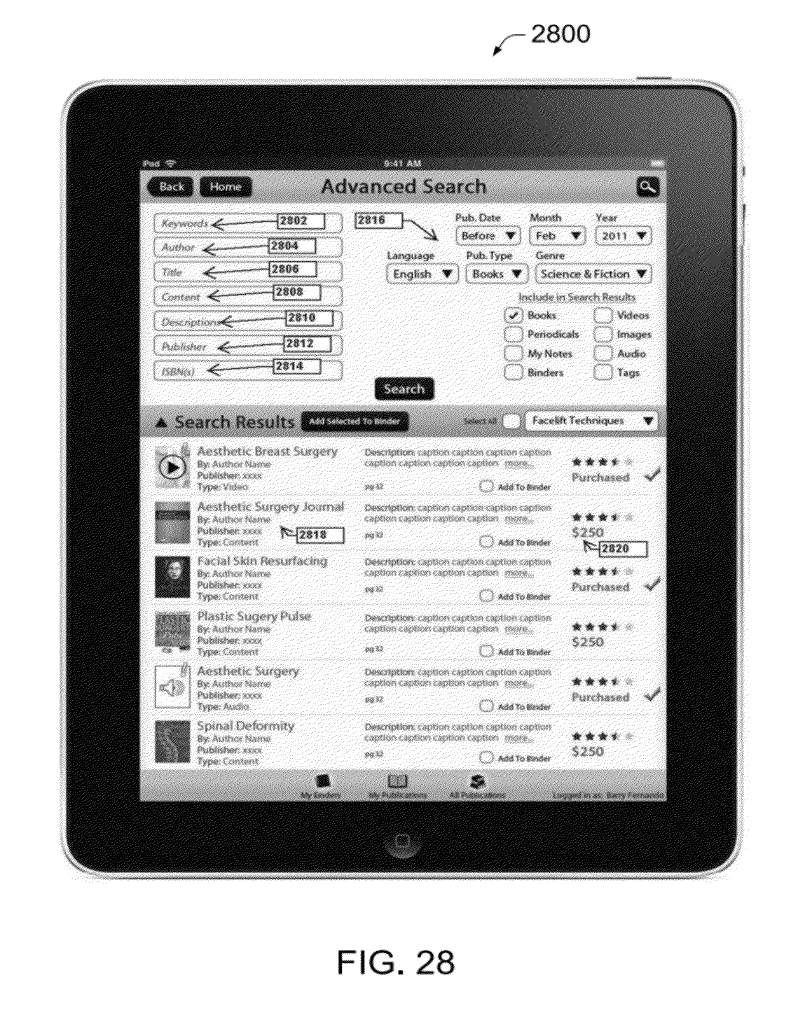

Referring to FIG. 28, in certain embodiments, the user conducts searches for electronic content via Advanced Search UI 2800. Here, several search parameters are available, such as: Keywords 2802, author 2804, title 2806, content 2808, descriptions 2810, publisher 2812, or ISBN 2814, for example. Other search parameters are also contemplated, such as publication date, language, publication type, genre, via element 2816. The search results can provide a list of electronic content, some of which may have already been purchased and others of which have not been purchased, either in whole or in part.

In certain embodiments, the user views the electronic content in the list even if the electronic content has not been licensed or purchased by the user. To illustrate, in FIG. 28 the user has not purchased the Aesthetic Surgery Journal, however, portions of the journal is rendered to the user by selecting the link to the Aesthetic Surgery Journal 2818. The user, in turn, purchases or receives a license to all or part of the electronic content.

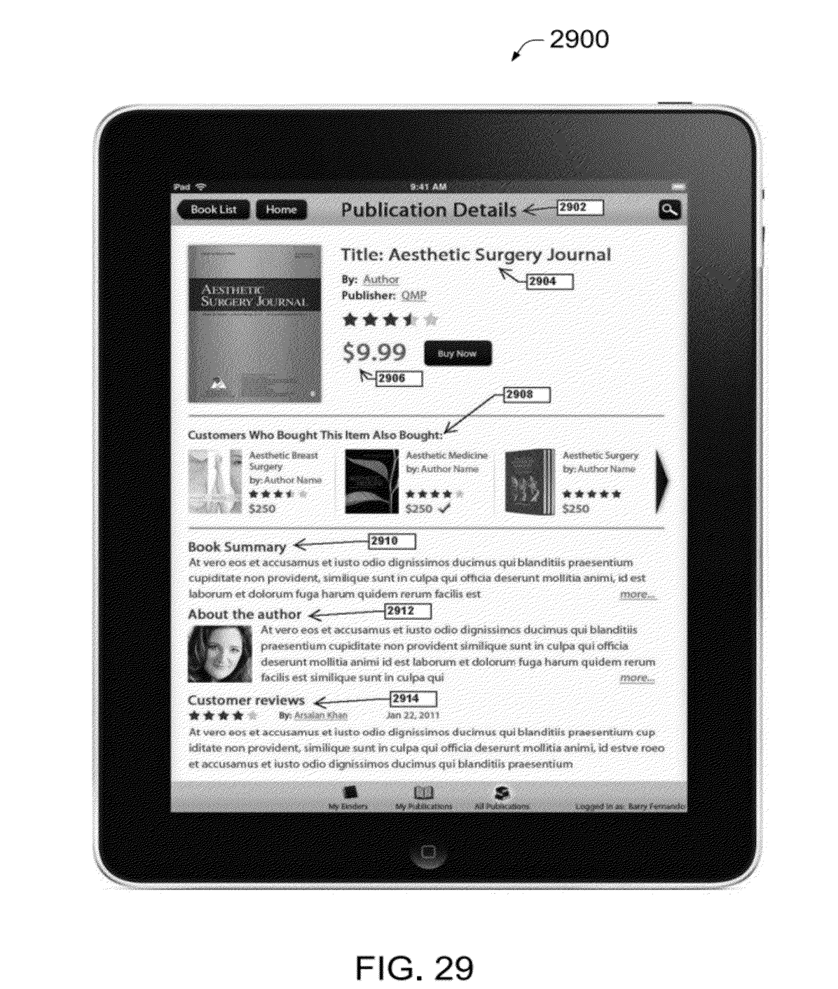

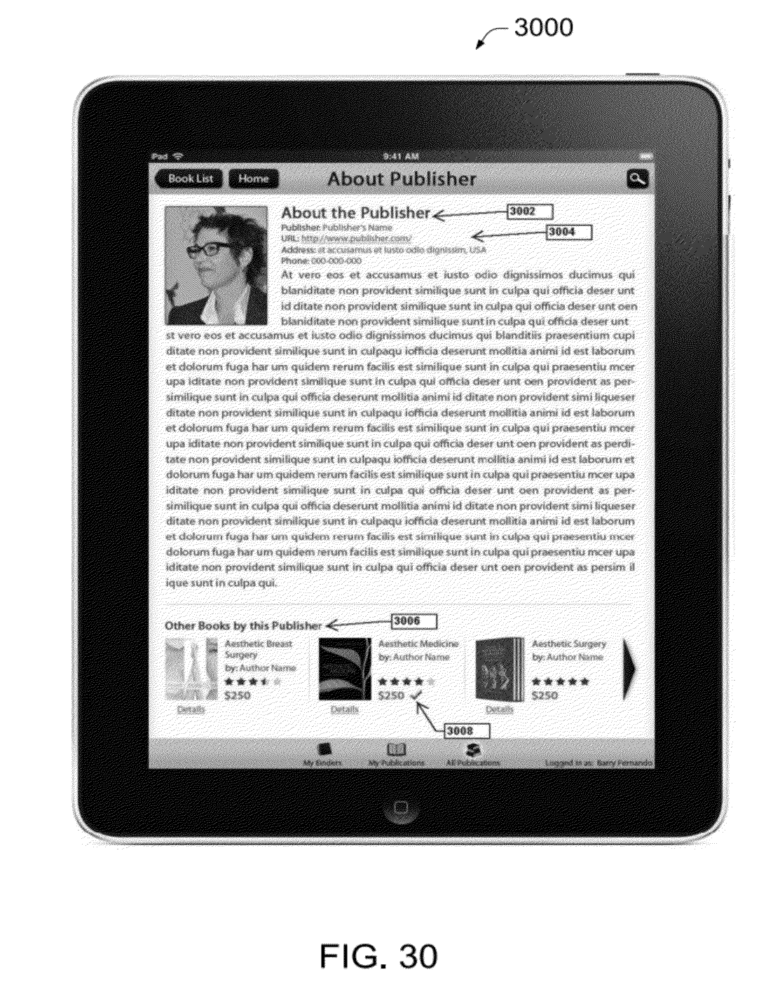

To illustrate and referring to FIG. 29, the user has an option to purchase a portion, such as a single chapter, of the Aesthetic Surgery Journal 2904 via Publication Details UI 2902. Here, although the license price for the entire electronic book was $250 (element 2820 of FIG. 28), the license price for a single chapter is only $9.99 (element 2906). Other electronic content that may be relevant to the selected content for the Aesthetic Surgery Journal 2904 is also rendered at 2908. In FIG. 29, the other relevant content is determined by past purchases of other users. Information about the selected content Aesthetic Surgery Journal 2904 is also available via corresponding links to: book summary 2910, data about the author 2912, or customer reviews 2914. Selection of the author link 2912 leads to Author UI 3000 of FIG. 30. In certain embodiments, Author UI 3000 also provides information about other books by the author 3006. Other information can also be made available to the user, such as data about the publisher of the selected content for the Aesthetic Surgery Journal 2904 of FIG. 29. Referring to FIG, 31, a Publisher UI 3100 provides data about the publisher 3102, such as: the publisher name or URL 3004. Data about other content by the publisher is also made available via element 3106. A check mark 3108 shows whether the other content has already been purchased.

In certain embodiments, the user can create her own interactive literature by uploading an electronic document with virtual objects and having the host computing device 106 associated video, audio and photos or slideshows or objects with selected regions or points on a page of the uploaded PDF. The multimedia content, in turn, is accessible via a link associated with a region of the page that activates a function to render the associated multimedia. Consequently, the user is able to make her own interactive documents that are remotely stored (e.g., at the data repository 118 of FIG. 1) and accessible by any of the user's user computing devices 116.

In certain embodiments, the electronic content is stored in a relational database that associates relevant electronic content and organizes them into virtual libraries that can include text books, profession specialty manual, journals, magazines, and the like. Custom views allow access to virtual libraries. Clients, publishers, and/or users create categories and/or subcategories in the virtual libraries and associates content, such as multimedia notes or reviews, to the respective electronic content in the virtual libraries. In certain embodiments, the user creates binders that include portions of content, across virtual libraries, in topical files.

In certain embodiments, the user can self publishes electronic content and make the self publication available to other users of the system 100 of FIG. 1. To illustrate, instead of having to create and print hundreds of page to make a sale of a paper books viable, the user can create an instructional multimedia file including, for example 25 page of instruction for surgery, a video of the procedure, and comments on recommended instruments for the procedure that is then made available to users of the system 100.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as a logical flow-chart diagrams (e.g., FIG. 6). As such, the depicted order and labeled steps are indicative of one embodiment of the presented method. In certain embodiments, other steps and methods are conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types are employed in the flow-chart diagrams, they are understood not to limit the scope of the corresponding method. Indeed, some arrows or other connectors may be used to indicate only the logical flow of the method. For instance, an arrow indicates a waiting or monitoring period of unspecified duration between enumerated steps of the depicted method. Additionally, the order in which a particular method occurs may or may not strictly adhere to the order of the corresponding steps shown.

In certain embodiments, individual steps recited in various processes are combined, eliminated, or reordered. In certain embodiments, the computer readable program code described resides in any other computer program product, where that computer readable program code is executed by a computer external to, or internal to, system 100 (FIG. 1), to perform one or more of steps recited processes described herein. In either case, the computer readable program code is encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. An article of manufacture comprising a processor and a non-transitory computer readable medium having computer readable program code encoded therein to provide remote access to virtual objects abstracted from an electronic document, the computer readable program code comprising a series of computer readable program steps to effect:
receiving an electronic document having one or more virtual objects, wherein said one or more virtual objects comprise one or more of: a text object, an image object, a sound object, a video object, an interactable graphic object, and a null object;
identifying (N) said virtual objects comprising said electronic document, wherein (N) is greater to or equal to 1;
forming an (i)th computer readable file encoding an (i)th virtual object, wherein (i) is less than or equal to (N);
encoding said (i)th computer readable file in said non-transitory computer readable medium;
creating an index referencing said (i)th computer readable file; and
encoding said index in said non-transitory computer readable medium.

2. The article of manufacture of claim 1, wherein:
said electronic document comprises a digitized image of a hard copy printed page;
the printed page comprises a text portion and an image portion;
the identifying (N) said virtual objects includes identifying said text portion and said image portion;
the forming an (i)th computer readable file includes:
forming a first computer readable file encoding said text portion; and
forming a second computer readable file encoding said image portion;
the encoding said (i)th computer readable file includes encoding said first computer readable file and said second computer readable file in said non-transitory computer readable medium;
and
creating an index includes creating an index referencing said first computer readable file and said second computer readable file.

3. The article of manufacture of claim 1, said computer readable program code further comprising a series of computer readable program steps to effect:
forming an (i)th identifier associated with said (i)th computer readable file; and
encoding said (i)th identifier in said non-transitory computer readable medium.

4. The article of manufacture of claim 3, wherein said computer readable program code further comprising a series of computer readable program steps to effect:
receiving (i)th metadata associated with said (i)th virtual object; and
wherein said identifying further comprises identifying said (i)th virtual object using said (i)th metadata;
associating said (i)th metadata with said (i)th identifier.

5. The article of manufacture of claim 1, wherein said computer readable program code further comprising a series of computer readable program steps to effect:
receiving from a first user a request to search said index using a search query;
searching said index using said search query;
identifying a matching computer readable file; and
providing, based on the first user access rights, said matching computer readable file to said first user.

6. The article of manufacture of claim 5, wherein providing said matching computer readable file includes:
when said first user's access rights to said index is verified, providing said matching computer readable file to said first user; and
when said first user's access rights to said index is unverified, denying the first user access to the matching computer readable file.

7. The article of manufacture of claim 1, wherein the computer readable program code further comprising a series of computer readable program steps to effect:
receiving an annotation associated with a (j)th virtual object, wherein (j) is less than or equal to (N);
receiving annotation metadata associated with at least the annotation; and
encoding the annotation and the annotation metadata in association with the respective computer readable file in the non-transitory computer readable medium.

8. The article of manufacture of claim 7, wherein the computer readable program code further comprising a series of computer readable program steps to effect:
creating second index referencing said annotation;
and
encoding said second index in said non-transitory computer readable medium.

9. The article of manufacture of claim 8, wherein the second index is encoded in association with a user library.

10. The article of manufacture of claim 7, wherein said computer readable program code further comprising a series of computer readable program steps to effect:
receiving from a first user a request to share with a second user at least one of: a portion of the electronic document and the annotation; and
providing the second user with at least one of: the portion of the electronic document and the annotation of the first user.

11. The article of manufacture of claim 10, wherein:
the electronic document is associated with a client library of a professional association; and
said computer readable program code further comprising a series of computer readable program steps to effect, prior to said providing the second user with the annotation, validating that the second user is a member in the professional association with an access right to the electronic document.

12. The article of manufacture of claim 7, wherein: the (j)th virtual object is a video object and the annotation is associated with a specified video frame of the video object.

13. The article of manufacture of claim 1, wherein said computer readable program code further comprising a series of computer readable program steps to effect:
requesting authorization to catalog the (i)th computer readable file in association with a client library of an entity;
receiving said authorization; and
encoding said (i)th computer readable file in said non-transitory computer readable medium in association with the client library, wherein access to said (i)th computer readable file is limited to users given access rights by the entity.

14. The article of manufacture of claim 1, wherein the electronic document is a trade journal and the entity is a professional organization issuing the trade journal.

15. A method for annotating a virtual object, the method comprising:
receiving an electronic document having one or more virtual objects, wherein said one or more virtual objects comprise one or more of: a text object, an image object, a sound object, a video object, an interactable graphic object, and a null object;
identifying (N) said virtual objects comprising said electronic document, wherein (N) is greater to or equal to 1;
forming an (i)th computer readable file encoding an (i)th virtual object, wherein (i) is less than or equal to (N);
encoding said (i)th computer readable file in said non-transitory computer readable medium;
receiving an annotation associated with a (j)th virtual object, wherein (j) is less than or equal to (N);
receiving annotation metadata associated with at least the annotation; and
encoding the annotation and the annotation metadata in association with the respective computer readable file in the non-transitory computer readable medium.

16. The method of claim 14, further comprising:
creating an index referencing said (i)th computer readable file;
encoding said index in said non-transitory computer readable medium;
creating a second index referencing said annotation; and
encoding said second index in said non-transitory computer readable medium in association.

17. The method of claim 15, further comprising:
receiving from a first user a request to share the annotation with a second user;
and
providing the second user with the annotation of the first user.

18. The method of claim 15, wherein:
the electronic document is associated with a client library of a professional association; and
further comprising, prior to said providing the second user with the annotation, validating that the second user is a member in the professional association with an access right to the electronic document.

19. A computer program product encoded in a non-transitory computer readable medium, the computer program product being useable with a computing device comprising a programmable processor provide remote access to virtual objects abstracted from an electronic document, the computer program product comprising:
computer readable program code which causes the programmable processor to receive an electronic document having one or more virtual objects and (i)th metadata associated with said (i)th virtual object, wherein said one or more virtual objects comprise one or more of: a text object, an image object, a sound object, a video object, an interactable graphic object, and a null object;
computer readable program code which causes the programmable processor to identify (N) said virtual objects comprising said electronic document using said (i)th metadata, wherein (N) is greater to or equal to 1;
computer readable program code which causes the programmable processor to form an (i)th computer readable file encoding an (i)th virtual object, wherein (i) is less than or equal to (N);
computer readable program code which causes the programmable processor to encode said (i)th computer readable file in said non-transitory computer readable medium;
computer readable program code which causes the programmable processor to create an index referencing said (i)th computer readable file; and
computer readable program code which causes the programmable processor to encode said index in said non-transitory computer readable medium.

20. The computer program product of claim 19, further comprising:
computer readable program code which causes the programmable processor to receive an annotation associated with a (j)th virtual object, wherein (j) is less than or equal to (N); and
computer readable program code which causes a programmable processor to receive annotation metadata associated with at least the annotation; and computer readable program code which causes a programmable processor to encode the annotation and the annotation metadata in association with the respective computer readable file in the non-transitory computer readable medium.
